(19) United States
(12) Patent Application Publication
(10) Pub. No.: US 2019/0145933 A1
(43) Pub. Date: May 16, 2019

(54) METHODS OF USING NONDESTRUCTIVE MATERIAL INSPECTION SYSTEMS

(71) Applicant: ExxonMobil Research and Engineering Company, Annandale, NJ (US)

(72) Inventors: Lang Feng, New York, NY (US); Qiuzi Li, Clinton, NJ (US); Harry W. Deckman, Clinton, NJ (US); Paul M. Chaikin, New York, NY (US); Neeraj S. Thirumalai, Easton, PA (US); Shiun Ling, Washington, NJ (US); Joseph W. Krynicki, The Woodlands, TX (US); Jamey A. Fenske, Spring, TX (US)

(21) Appl. No.: 16/164,976

(22) Filed: Oct. 19, 2018

Related U.S. Application Data
(60) Provisional application No. 62/585,191, filed on Nov. 13, 2017.

(51) Int. Cl. G01N 27/90

(52) U.S. Cl. CPC G01N 27/902; G01N 27/9093; G01N 27/904

(57) ABSTRACT

Provided is a method of utilizing a nondestructive evaluation method to inspect/screen steel components (like plates), steel metal pipes, and seam welds and girth welds of the pipes to identify material phases and assess material qualities. The method includes: providing a DC magnetic field from a magnet to a steel plate, pipe, or weld composed of at least one hysteretic ferromagnetic material followed by scanning the plate, pipe, or weld and recording magnetic responses from two or more suitable sensors disposed at locations with different magnetic field strengths in the regions of interest configured to receive magnetic responses; and correlating all the said received magnetic responses to one or more material qualities and/or material phases of the plate, pipe, or weld. The one or more material qualities includes regions of higher hardness, regions of metal loss, regions of surface cracks, amount of undesirable phases, and combinations thereof.

### CROSS-REFERENCE TO RELATED APPLICATIONS

This application claims priority to U.S. Provisional Application No. 62/585,191 entitled “Methods Of Using Nondestructive Material inspection Systems” filed on Nov. 13, 2017, which is hereby incorporated by reference here in its entirety. This application is also related to three other co-pending U.S. provisional applications, filed on Nov. 13, 2017: U.S. Provisional Application No. 62/585,177 entitled “Methods And Systems For Nondestructive Material Inspection”; U.S. Provisional Application No. 62/585,185 entitled “Methods Of Using Nondestructive Material Inspection Systems”; and U.S. Provisional Application No. 62/585,167 entitled “Methods And Systems For Nondestructive Material Inspection”, each of which are hereby incorporated by reference here in their entirety.

### FIELD

The present disclosure relates to material inspection, more specifically to nondestructive material inspection. It relates more particularly to methods of using non-destructive material inspection systems.

### BACKGROUND

Systems and methods to evaluate hard spots and/or other suitable material qualities (e.g., in pipeline steel or other suitable materials) for nondestructive inspection of pipeline, piping, steel plates, welded structures, and welds of different types that can include but not limited to girth welds, fillet welds, lap welds, and butt welds are valuable in determining material integrity (e.g., pipeline integrity). Such systems and methods for example, can obtain information on pipeline materials nondestructively on such materials. Currently, pipeline inspection gauges and tools (PIGS) are being used to perform nondestructive inspection to detect anomalies and flaws in a pipe, such as cracks and hard spots. Similarly, welds are non-destructively inspected using technologies including magnetic particle testing, ultrasonic testing, and eddy current testing. The most commonly used nondestructive inspection technologies include magnetic flux leakage (MFL)and ultrasonic crack detection tool (UT). These inspection technologies are based on the principle that the anomalies and flaws possess some material properties that are detectably different from that of the bulk material of the pipeline, e.g. MFL detects the leaked magnetic flux due to difference in magnetic permeabilities, and the UT detects the reflected ultrasonic signals due to difference in mechanical vibration behaviors. Because of the importance of material integrity as well as material and weld quality, there is a continuous need to further improve the art of nondestructive material inspection technologies, through improving current technologies, as well as developing new inspection technologies and uses of such inspection technologies. The present disclosure provides a new inspection technology solution for this need.

### SUMMARY

In accordance with at least one aspect of this disclosure, a device for detecting one or more material qualities of a sample composed of at least one hysteretic ferromagnetic material.

The device includes a magnet configured to provide a DC magnetic field which has a spatially varying magnetic field in at least a portion of the regions of interest, and two or more suitable sensors disposed at locations with different magnetic field strengths in the regions of interest configured to receive magnetic responses. In one embodiment, it can be a first sensor disposed at a first location relative to the magnet and configured to receive a first magnetic response, and a second sensor disposed at a second location relative to the magnet and configured to receive a second magnetic response. The device can also include a processor, configured to execute a method that comprises recording magnetic responses received from the two or more suitable sensors disposed at the said different locations, and correlating all the said received magnetic responses to one or more material qualities of the said sample composed of at least one hysteretic ferromagnetic material.

In certain embodiments, the device can include an indicator configured to indicate to a user the one or more material qualities of the sample. In another embodiment, the device can send indications in real time to a remote user through wireless communication technology. In yet another embodiment, the device can record all indications, for later retrieval and download either on-site or at remote locations for post processing.

In certain embodiments, the one or more material qualities can include, but is not limited to, a material phase of the hysteretic ferromagnetic material or non-hysteretic material. In certain embodiments, the one or more material qualities can include, but is not limited to, a material flaw.

The hysteretic ferromagnetic material can include any material in which the relationship between magnetic field strength and magnetization is not linear. In certain embodiments, the hysteretic ferromagnetic material can include, but is not limited to steel, nickel, cobalt, silicon steel, and their alloys, such as a variety of carbon steels.

In certain embodiments, the non-hysteretic material can include, but is not limited to, air, aluminum, austenitic stainless steel, duplex stainless steel, and high manganese steel.

In certain embodiments, the material phase can include, but is not limited to, at least one of austenite, martensite, ferrite, pearlite, bainite, acicular ferrite, and quasi-polygonal ferrite with different chemical compositions and/or crystallographic orientations.

In certain embodiments, the magnet that provides a DC magnetic field can include, but is not limited to, one or more permanent magnets that can form a horseshoe magnet. Any other suitable magnet type (e.g., electromagnet) or shape is contemplated herein. In certain embodiments, the magnet to provide a DC magnetic field could be made of, but is not limited to, a combination of multiple types of magnets, such as electromagnets, permanent magnets such as Neodymium magnets and ceramic magnets, and superconducting magnets.

The spatially varying magnetic field can include, but is not limited to, the magnetic field strengths that vary at different locations relative to the magnet. In certain embodiments, the spatially varying magnetic field can include the difference of magnetic field strengths in the center and the trailing side of the magnet.

The regions of interest can include, but are not limited to, the following: the center of the magnet close to the material being inspected, the trailing side of the magnet close to the material being inspected, etc.

In certain embodiments, two or more suitable sensors can be disposed at different locations relative to the magnet. Each sensor can include, a multi-axis (e.g., three axes) Hall sensor or a cesium atomic magnetometer; however any suitable sensor for sensing a magnetic field is contemplated herein. In one embodiment, one of the two or more suitable sensors can be disposed at the center of the horseshoe magnet. One of the two or more suitable sensors can be disposed outside of the horseshoe magnet. For example, one of the two or more suitable sensors can be disposed on the trailing side of the horseshoe magnet.

Magnetic responses can include, but is not limited to, the magnetic fields measured by all the said suitable sensors. In certain embodiments, magnetic responses can also include the spatially varying magnetic response measured at the said suitable sensor as the said suitable sensor moving in the regions of interest.

Recording magnetic responses can include, but is not limited to, recording magnetic responses real time with a computer on board. Recording magnetic responses could also include, but is not limited to, storing at the time of signal acquisition to a. computer readable storage media with sufficient information which can be used for post processing.

In certain embodiments, the device could be embedded to handheld tool, a computer-controlled automatic moving platform such as a robotic arm, or an externally driven moving tool such as a pipeline inspection gauge (PIG). In a specific embodiment, the device can be incorporated on a pipeline inspection gauge to detect the hysteretic ferromagnetic material and identify regions with higher hardness or metal loss or cracks feature of the pipe.

In accordance with east one aspect of this disclosure, a method for determining one or more qualities of a sample composed of at least one hysteretic ferromagnetic material can include providing a DC magnetic field from a magnet to the said sample composed of at least one hysteretic ferromagnetic material, recording the magnetic responses received at two or more suitable sensors disposed at locations with different magnetic field strengths in the regions of interest; and correlating all the said received magnetic responses to one or more material qualities of the said sample composed of at least one hysteretic ferromagnetic material. In one embodiment, the method can include receiving a first magnetic response at a first sensor disposed at a first location, receiving a second magnetic response at a second sensor, and correlating both of the first and the second magnetic responses to one or more material qualities of the sample,.

The method can include moving the magnet, and two or more suitable sensors together along a surface to be analyzed. In one embodiment, correlating the magnetic responses can include, but is not limited to, correlating all the magnetic responses to the presence of a material phase. In another embodiment, correlating can include, but is not limited to, correlating all the magnetic responses to the occurrence of a material flaw.

In accordance with at least one aspect of this disclosure, a non-transitory computer readable medium can include instructions for performing a method. The method comprising recording magnetic responses from two or more suitable sensors disposed at locations with different magnetic field strengths in the regions of interest, and correlating all the said received magnetic responses to one or more material qualities of the said sample composed of at least one hysteretic ferromagnetic material. Correlating can include, but is not limited to, correlating all the said received magnetic responses to a material phase. Correlating can also include, but is not limited to, correlating all the said received magnetic responses to a material flaw. The method can include sending an indicator signal if the detected material quality deviates from the acceptable range of material quality. The method can also include sending an indicator signal to remote user if the detected material quality deviates from the acceptable range of material quality. The method can also include recording an indicator signal for later retrieval or download for post-processing and follow-up actions if the detected material quality deviates from the acceptable range of material quality.

In accordance with another aspect of this disclosure, provided is a method of utilizing a nondestructive evaluation method to inspect/screen a steel component (e.g., steel metal plates, bolts, forgings, castings, and the like) composed of at least one hysteretic ferromagnetic material to identify material phases and assess regions with higher hardness or metal loss or cracks on the surface or in the bulk of the steel component comprising the steps of: providing a DC magnetic field from a magnet to a steel component composed of at least one hysteretic ferromagnetic material; scanning the steel component and recording magnetic responses from two or more suitable sensors disposed at locations with different magnetic field strengths in the regions of interest configured to receive magnetic responses; and correlating all the said received magnetic responses to one or more material qualities of the steel component, wherein said one or more material qualities includes regions of higher hardness, regions of metal loss, regions of surface cracks, amount of undesirable phases and combinations thereof.

In accordance with still another aspect of this disclosure, provided is a method of utilizing a nondestructive evaluation method to screen steel pipeline seam welds composed of at least one hysteretic ferromagnetic material to identify material phases and assess regions with higher hardness or metal loss or cracks comprising the steps of: providing a DC magnetic field from a magnet to a steel pipeline composed of at least one hysteretic ferromagnetic material; scanning the steel pipeline and recording magnetic responses from two or more suitable sensors disposed at locations with different magnetic field strengths in the regions of interest configured to receive magnetic responses; and correlating all the said received magnetic responses to one or more material qualities of the seam weld of the steel pipeline, wherein said one or more material qualities includes regions of higher hardness, regions of metal loss, regions of surface cracks, amount of undesirable phases, and combinations thereof.

In accordance with still yet another aspect of this disclosure, provided is a method of utilizing a nondestructive evaluation method to screen girth welds in the systems composed of at least one hysteretic ferromagnetic material to identify material phases and assess regions with higher hardness or metal loss or cracks comprising the steps of providing a DC magnetic field from a magnet to a steel pipe composed of at least one hysteretic ferromagnetic material; scanning the root and/or cap of a girth weld and recording magnetic responses from two or more suitable sensors disposed at locations with different magnetic field strengths in the regions of interest configured to receive magnetic responses; and correlating all the said received magnetic responses to one or more material qualifies of the one or more girth welds of the steel line pipes, wherein said one or more material qualities includes regions of higher hardness, regions of metal loss, regions of surface cracks, amount of undesirable phases, and combinations thereof.

In accordance with still yet another aspect of this disclosure, provided is a method of utilizing a nondestructive evaluation method to screen welds of steel piping or pipes or structure including but not limited to girth welds or fillet welds or lap welds or butt welds in systems composed of at least one hysteretic ferromagnetic material to identify material phases and/or material qualities of welds comprising the steps of: interrogating the hysteretic ferromagnetic material with an input time varying magnetic field; scanning the root and/or cap of a weld and detecting a magnetic response andior acoustic response over time from the hysteretic ferromagnetic material; determining a time dependent nonlinear characteristic of the received magnetic response and/or acoustic response; and correlating the time dependent nonlinear characteristic of the received magnetic response and/or acoustic response to one or more material qualities and/or material phases of the one or more welds of the steel piping or pipes or structure, wherein said one or more material qualities includes regions of higher hardness, regions of metal loss, regions of surface cracks, amount of undesirable phases, and combinations thereof.

In accordance with still yet a further aspect of this disclosure, provided is a method of utilizing a nondestructive evaluation method to identify material phases in steel components (e.g., steel metal plates, bolts, forgings, castings, and the like) and welds of pipeline or piping or welded structures, and welding types and heat treatment states of steel components, and welds of pipeline or piping or welded structures composed of at least one hysteretic ferromagnetic material comprising the steps of: providing a DC magnetic field from a magnet to a steel component or steel pipeline composed of at least one hysteretic ferromagnetic material; scanning the steel component or steel pipeline or piping or welded structure and recording magnetic responses from two or more suitable sensors disposed at locations with different magnetic field strengths in the regions of interest configured to receive magnetic responses; and correlating all the said received magnetic responses to one or more material qualities of the steel components or welds of pipeline or tubulars or piping or welded structure, wherein said one or more material qualities includes regions of higher hardness, regions of metal loss, regions of surface cracks, amount of undesirable phases, and combinations thereof.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIGS. 1A and 1B show magnetic hysteresis curves for ferrite (solid line) and martensite (dot-dashed line), wherein in FIG. 1A, full hysteresis curves for ferrite (solid line) and martensite (dot-dashed line) are shown; wherein in FIG. 1B, a zoom-in of initial magnetization curves for ferrite (solid line) and martensite (dot-dashed line) are shown.

FIG. 2A is a schematic view of an embodiment of a device in accordance with this disclosure;

FIG. 2B shows center sensor measurements of the magnetic flux along X-axis for different flaws, including that measured with different thicknesses of air gap, and that measured with ferrite coupon, and martensite coupon.

FIG. 3A shows the experimental data of peak magnetic flux measured with different thicknesses of air gap;

FIG. 3B shows computer simulation results of peak magnetic flux with different thickness of air gap;

FIG. 4A-4D shows magnetic flux density measurements for a 308 μm air gap, wherein FIGS. 4A and 4B show the experimental data, wherein FIGS. 4C and 4D show the computer simulation results, wherein FIGS. 4A and 4C plot the magnetic flux density measured by the trailing sensor, and wherein FIGS. 4B and 4D plot the magnetic flux density measured by the center sensor;

FIGS. 5A and 5B show experimental measurement of magnetic flux in presence of martensite or 38 μm air gap, wherein FIG. 5A shows magnetic flux density measured by the center sensor, and FIG. 5B shows magnetic flux density measured by the trailing sensor;

FIGS. 6A and 6B show representations of a magnetic detection system used in the computer simulation, wherein FIG. 6A shows a schematic diagram of the system that comprises a horseshoe permanent magnet moving along the wall of a steel pipe, and FIG. 6B shows a zoom-in of FIG. 6A when the permanent magnet passes a flaw;

FIGS. 7A-7D shows a 2D axial symmetric computer simulation of a horseshoe magnet on the steel pipe wall, wherein FIGS. 7A and 7B correspond to the vertical z-component and the horizontal r-component of magnetic flux density in the horseshoe magnet and pipe wall in the presence of 4.35 mm martensite phase, and wherein FIGS. 7C and 7D correspond to the vertical z-component and the horizontal r-component of magnetic flux density in the presence of 38 μm air gap, respectively; and

FIGS. 8A-8D shows a 2D axial symmetric computer simulation results for multi-point sensing and low magnetic flux detection of martensite/air gap phase, wherein FIGS. 8A and 8B show simulation of the vertical z-component of magnetic flux measured by the magnetic sensor with maximum magnetic flux around 0.2 T in the pipeline wall, and wherein FIGS. 8C and 8D show the same computer simulation for the horizontal r-component of magnetic flux measured by the magnetic sensor.

FIGS. 9A and 9B show a Thermo-Mechanical Controlled Processing (TMCP) method for forming hot rolled steel plate where the disclosed magnetic detection methods and systems are incorporated in an inspection device capable of scanning the TMCP plate surface after the accelerated cooling step of the TMCP process.

FIG. 10A shows the disclosed magnetic detection methods and systems incorporated in one or more inspection devices on a pipeline inspection gauge (PIG) capable of inspecting or scanning the inside diameter (ID) of the pipe and FIG. 10B is a flow chart of the steps involved in determining the amount of undesirable phases during pipeline inspection and then determining the appropriate course of action for the line pipe (for example, replacing or remediating by suitable metallurgical treatments such as tempering or annealing).

FIG. 11A shows the disclosed magnetic detection methods and systems incorporated in one or more inspection devices on a. manual (e.g., tethered or pulled system) or automatic (e.g., robotic crawler) inspection tool capable of inspecting/scanning the ID or a manual or automatic system for the inspection of outside diameter (OD) of the pipe, and more particularly an ID is inspection tool for scanning root of the girth weld and FIG. 11B is a flow chart of the steps involved in determining the amount of undesirable phases and if the amount of undesirable phases are above the threshold, the girth weld is then removed/cut-out and replaced with a new girth weld or remediated by suitable metallurgical treatments such as applying a temper beading technique for the next weld pass (e.g., after the root pass or root and hot pass at the ID) or post weld heat treatment (e.g., tempering or normalizing) before proceeding to the next girth weld.

FIG. 12A shows the disclosed magnetic detection methods and systems incorporated into a handheld inspection device capable of inspecting/scanning various metals including carbon steel materials and FIG. 12B is a flow chart of the steps involved in determining the amount of undesirable phases and if the amount of undesirable phases are above the threshold at a specific location, the steel materials at that location are replaced or remediated by suitable treatments such as tempering.

### DETAILED DESCRIPTION

All numerical values within the detailed description and the claims herein are modified by “about” or “approximately” the indicated value, and take into account experimental error and variations that would be expected by a person having ordinary skill in the art. The current invention relates to methods of using non-destructive material inspection systems using methods and apparatus to detect the magnetic response of a sample composed of at least one hysteretic ferromagnetic material. The magnetic response of such a sample is given by the equation

B(x)=μ₀(H(x)+M(x))=F(H(x))

where H(x) is the applied magnetic field strength (unit of ampere/meter) which can vary with position (x) in space. M(X) is the magnetization (unit of ampere/meter) which depends on position (x) as well as the initial magnetization state of the material, μ₀ is the magnetic permeability constant (unit of henry/meter), B(x) is the magnetic flux density (unit of Tesla), and F(H(x)) is a function that depends on H(x) as well as the initial magnetization state of the material. This type of dependence is seen in static applied magnetic fields as well magnetic fields that change relatively slowly with time. Currently, practiced magnetism based inspection tools, such as magnetic flux leakage (MFL), are generally configured to apply a magnetic field through the steel specimen, and use a sensor located adjacent to the steel specimen to detect the resulting “leakage” of the B(x) from the steel specimen. The leakage is typically measured at one point in space, or for a pipe with multiple sensors configured around the inner circumference of the pipe in an approximately planar array. For magnetic flux leakage tool the magnetic response (flux leakage) is measured in a region with high flux density in the hysteretic ferromagnetic material. Anomalies and flaws such as inhomogeneities (e.g., cracks or hard spots) or changes in the composition of the ferromagnetic material alter the flux leakage. Many types of anomalies and flaws found in ferromagnetic material (such as cracks or hard spots) are difficult to detect using current magnetism based inspection technologies such as MFL, because these anomalies and flaws do not induce sufficiently large change in magnetic flux leakage. The present invention overcomes this limitation by using two or more suitable sensors which are located in proximity to regions adjacent to the specimen that have higher values of the B(x), as well as regions that have lower values of the B(x). In one embodiment, two sensors can be used to measure two different leakage B. In another embodiment, multiple sensors can be used to measure multiple values of the leakage B. In some cases, two arrays of sensors can be positioned to perform measurements near regions having higher and lower B, respectively. This configuration is particularly useful when inspecting pipelines. It is also possible to utilize multiple arrays of sensors to measure regions adjacent to steel pipeline wall that have multiple applied B. In one embodiment, the higher value of the B is higher than 10 T, preferably higher than 1 T, preferably higher than 0.1 T. In one embodiment, the lower value of the B can be lower than 0.5 T, preferably lower than 0.05 T, lower than 0.005 T, or even lower than 0.0005 T. In one embodiment, the distance between flux leakage sensor and the specimen is less than 20 centimeters, preferably less than 1 centimeter, and even more preferably less than 0.1 centimeters. In one embodiment, the distance between the two or more suitable sensors is less than 1 meter, preferably less than 0.1 meters, and could also be less than 0.01 meters.

Examples of anomalies, flaws, and qualities in samples that can be detected using the systems, devices, and method of the present invention include, but are not limited to, the hardness of welds and changes therein, the hardness of the material and changes therein used to produce or in pipes or similar structures, the grade of the material used to produce or in pipes or similar structures, the type of weld, the hardness of the material and changes therein, the presence of a material phase in the material (e.g., the presence of a hard steel phase such as martensite or bainite in carbon steel, nonhysteretic material phases in hysteretic ferromagnetic materials and hysteretic magnetic material phases in nonhysteretic materials), the presence of hard spots in the material, the presence of metal loss or cracks in the material (e.g., stress corrosion cracks), the presence of defects in the material, and combinations thereof.

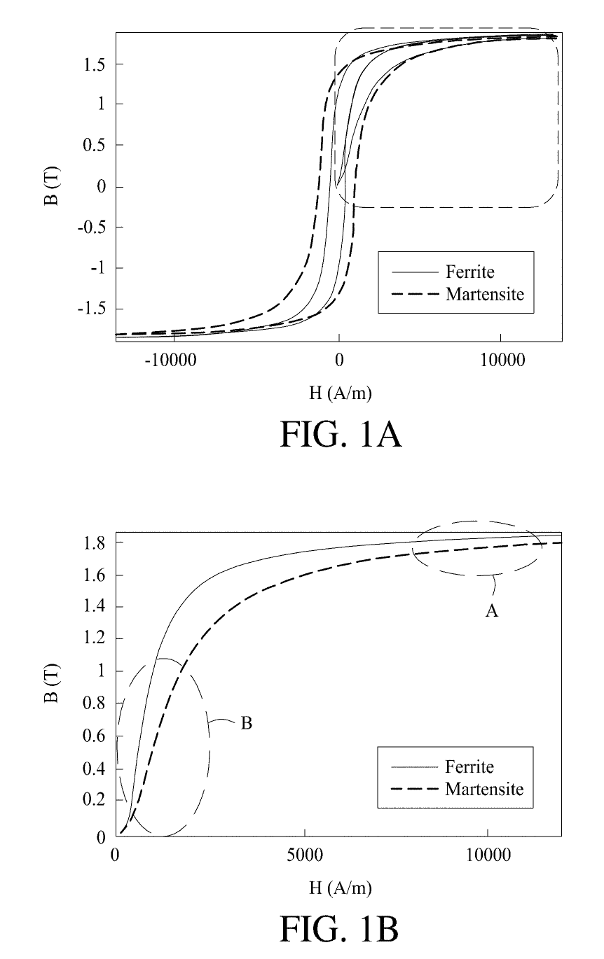

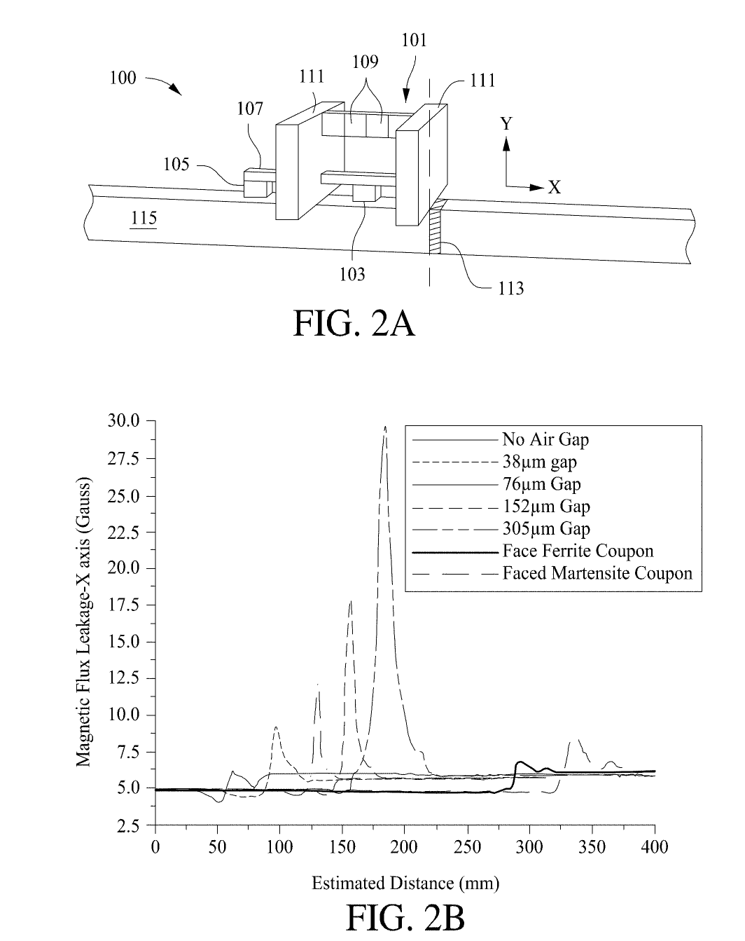

Reference will now be made to the drawings wherein like reference numerals identify similar structural features or aspects of the subject disclosure. For purposes of explanation and illustration, and not limitation, an illustrative view of an embodiment of a method in accordance with the disclosure is shown in FIG. 2 and is designated generally by reference character 100. Other embodiments and/or aspects of this disclosure are shown in FIGS. 1A, 1B, and FIGS. 3A-8D. The systems and methods described herein can be used to determine a quality of a material (e.g., a material phase and/or anomalies and flaws in a metal pipeline or a metal component (e.g., steel metal plates, bolts, forgings, castings, and the like)).

In the past few decades, pipeline inspection tools, known as PIGs, have been used to perform nondestructive inspection of steel pipelines to detect cracks in the pipe wall. The most widely used nondestructive inspection technology is the magnetic flux leakage (MFL). The currently available MFL is not designed to, and is not capable of distinguishing the metallurgy phases commonly found in pipeline steels, the ferrite, and martensite phases. The reason is that the current MFL applies high magnetic field to the steel pipeline wall, but the magnetic properties of martensite and ferrite phases are almost indistinguishable under high magnetic modulation. The magnetic properties between martensite and ferrite phases are larger under low magnetic modulation, but still cannot be detected using the currently available low field magnetic flux leakage techniques, which rely on a single point measurement on the magnetic hysteresis loop that severely limits the measurement sensitivity.

This disclosure is based on results obtained from extensive experimentation and computer simulation, and embodiments of multipoint sensing and low magnetic flux systems are disclosed and can be used for detecting and distinguishing magnetic materials with different hysteresis curves, e.g., differentiating a hard phase or metal loss feature (e.g., a gap, or a crack) from a soft ferrite phase. The fundamental principle of this method is based on the fact that the magnetization and demagnetization processes in hard phase are different to that in a metal loss feature. In other words, the magnetization and demagnetization processes in hard phases are irreversible, hysteretic, and are functions of external magnetic field, whereas that in the metal loss feature are reversible, non-hysteretic, and independent of external field because the magnetic permeability of a metal loss feature is independent of external magnetic field. Moreover, the magnetic properties of the ferrite and martensite phases both strongly depend on the external magnetic field, but they have differences that are most pronounced under low magnetic modulation. This unique fingerprint can be useful for distinguishing a hard phase from a soft ferrite phase, as well as for distinguishing the metal loss feature from both martensite and ferrite to phases in steels. Any other use is contemplated herein.

In the pipeline and oil and gas industry, carbon and low alloy steels are commonly used in the construction of pipelines. Generally, soft ferrite is the dominating phase in these steels. A hard phase such as the martensite phase could form when these steels have been subjected to rapid quenching from high temperature (e.g,, above 900° C.) to room temperature. Such rapid quenching could happen either intentionally or accidentally during common steel processing or welding, such as steel component (e.g., steel metal plates, bolts, forgings, castings, and the like) manufacturing or electrical resistance seam welding process, for example. The presence of hard phase in steels can be particularly disadvantageous because it is more susceptible to cracking and failures than the soft ferrite phase. As a result, a nondestructive technique to detect and differentiate martensite from ferrite in the steels is valuable to the industry. Embodiments may be used to detect the difference in magnetic hysteresis parameters between ferrite and martensite phases and differentiate them.

FIGS. 1A and 1B show the magnetic hysteresis responses of ferrite and martensite phases generated using computer simulations. The hysteresis models used are commonly known as the J-A model. There are five parameters in the J-A model to describe the hysteretic response of a specific material, and in our simulations these five parameters have been obtained by best fitting the J-A hysteresis curves to suitable experimental data from literature. For ferrite and martensite phases, two different sets of parameters were obtained and the full hysteresis curves are generated using computer simulation, and the results are shown in FIG. 1A. The solid curve is for the ferrite phase and the dot-dashed curve is for the martensite phase.

A COMSOL MULTIPHYSICS® package was used to perform finite element based computer simulation magnetic behaviors and responses of systems that contain hysteretic ferromagnetic steel phases, ferrite and martensite phases, which have magnetization and demagnetization behaviors as shown in FIG. 1A. The computer simulation incorporates a full Maxwell equation solver with five J-A parameters to account for the full hysteretic ferromagnetic properties of both ferrite and martensite phases. The multi-point sensing and low magnetic flux technique, uses the properties of the magnetic hysteresis loop in the region of FIG. 1A inside the black clashed-line square. FIG. 1B is a zoom in of the initial part of the magnetization curves shown in FIG. 1A. Current magnetic sensing devices (e.g. in MFL inspection tool) generally use high magnetic saturation field, shown as the region A in FIG. 1B. In this high magnetic field regime, the magnetic properties between ferrite and martensite are very similar. Embodiments disclosed herein instead perform measurement in the low magnetic field regime, shown as the region B in FIG. 1B. In this low magnetic field regime, the difference in the magnetic properties to between ferrite and martensite phases is more pronounced, which allows for improved accuracy in distinguishing these two phases. In certain embodiments disclosed herein, the low magnetic field region is attained by using a magnet with low magnetic flux (e.g., a permanent magnet) to measure magnetic responses with multiple sensors.

Referring to FIG. 2A, a device 100 for detecting one or more material qualities of a sample composed of at least one hysteretic ferromagnetic material 115 includes a magnet 101 configured to provide a DC magnetic field. The device 100 includes a first sensor 103 disposed at a first location relative to the magnet 101 and configured to receive a first magnetic response. The device 100 includes and a second sensor 105 disposed at a second location relative to the magnet 101 and configured to receive a second magnetic response. The first and second sensors 103, 105 are held in place with a bar 107.

The device 100 can also include a processor configured to execute a method, the method comprising, but is not limited to, receiving the magnetic responses from two or more suitable sensors disposed at the said different locations, recording these received magnetic responses, and correlating all the said received magnetic responses to one or more material qualities of the said hysteretic ferromagnetic material being inspected. In certain embodiments, the method can include receiving a first magnetic response from the first sensor 103 disposed at the first location, receiving a second magnetic response from the second sensor 105, and correlating both of the first magnetic response and the second magnetic response to one or more material qualities of a sample 115. In certain embodiments, the material being inspected can include a hysteretic ferromagnetic material or a non-hysteretic material. A hysteretic ferromagnetic material can include any material in which the relationship between magnetic field strength and magnetization is not linear. In certain embodiments, a hysteretic ferromagnetic material can include, but is not limited to steel, nickel, cobalt, silicon steel, and their alloys, such as a variety of carbon steels. In certain embodiments, the non-hysteretic material can include, but is not limited to, air, aluminum, austenitic stainless steel, duplex stainless steel, and high manganese steel. The one or more material qualities of interest can include, but is not limited to, a material phase of the hysteretic ferromagnetic material or non-hysteretic material. In certain embodiments, a material phase can include, but is not limited to, at least one of austenite, martensite, ferrite, pearlite, bainite, acicular ferrite, and quasi-polygonal ferrite.

The device 100 can include an indicator (e.g., one or more LEDs, a display, a readout, an audible indicator, a tactile indicator, or any suitable indicator) configured to indicate to a user the one or more material qualities of the sample 115. In certain embodiments, the device 100 can send indications in real time to a remote user through wireless communication technology. In yet to another embodiment, the device 100 can record all indications, for later retrieval and download either on-site or at remote locations for post processing.

In certain embodiments, the material phase, 113, can include, but is not limited to, at least one of austenite, martensite, pearlite, bainite, acicular ferrite, and quasi-polygonal ferrite with different chemical compositions and/or crystallographic orientations. In certain embodiments, the material phase 113 can include, but is not limited to, a material flaw (e.g., a metal loss feature a crack, corrosion caused pit or wall thinning, etc.).

Correlating can include, but is not limited to, correlating all the received magnetic responses from the sensors to a material phase. Correlating can include, but is not limited to, correlating all the received magnetic responses from the sensors to a material flaw.

The device could be embedded to a handheld tool, a computer-controlled automatic moving platform such as a robotic arm, or an externally driven moving tool such as a pipeline inspection gauge (PI(i). In one embodiment, the device can be incorporated on a pipeline inspection gauge to identify pipeline sections more susceptible to cracking, by detecting the presence of certain hysteretic ferromagnetic material having higher hardness, or the presence of certain material flaws.

In certain embodiments, the magnet 101 includes one or more permanent magnets 109. The one or more permanent magnets 109 can form a horseshoe magnet (e.g., with metal plates 111). Any other suitable magnet type (e.g., electromagnet) or shape is contemplated herein. In certain embodiments, the magnet 101 to provide a DC magnetic field could be made of, but is not limited to, a combination of multiple types of magnets, such as electromagnets, permanent magnets such as Neodymium magnets and ceramic magnets, and superconducting magnets.

The spatially varying magnetic field can include, but is not limited to, the magnetic field strengths that vary at different locations relative to the magnet. In certain embodiments, the spatially varying magnetic field can include the difference between the local magnetic field strengths at the center of the magnet 109 (e.g., measured by sensor 103) and that are behind the magnet 109 (e.g., measured by sensor 105).

The regions of interest can include, but are not limited to, the following: the center of the magnet close to the material being inspected, the trailing side of the magnet close to the material being inspected, etc.

In certain embodiments, the first sensor 103 can be disposed in a center of the horseshoe magnet close to the material being inspected. The second sensor 105 can be disposed on the trailing side of the horseshoe magnet close to the material being inspected. For example, the second sensor 105 can be disposed on the trailing side of the horseshoe magnet, wherein the to device 100 is moved from left to right along the surface of the material 115 in the embodiment shown. The first sensor 103 and second sensor 105 can each include a multi-axis (e.g., three axes) Hall sensor or a cesium atomic magnetometer; however any suitable sensor for sensing a magnetic field is contemplated herein.

Magnetic responses can include, but are not limited to, the magnetic fields measured by all the said suitable sensors. In certain embodiments, magnetic responses can also include the spatially varying magnetic response measured at the said suitable sensor as the said suitable sensor moving in the regions of interest.

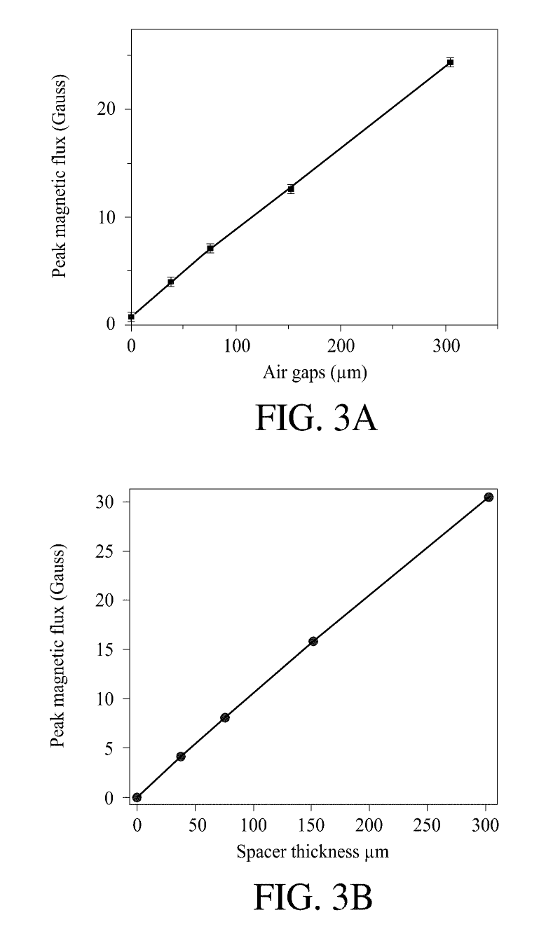

Computer simulations were performed to evaluate the magnetic behaviors of the system shown in FIG. 2A, and the simulation results are validated by comparing them with experimental measurements, and the results are shown in FIGS. 2B and 3A-3B. This experimental set up is described below with reference to the ernbodirnent shown in FIG. 2A. The experimental setup included two 3-axis Hall sensors are used to measure magnetic flux densities. The first one was used as the center sensor 103, and the second one was the trailing sensor 105.

In the experiment, a carbon steel bar was used as the material 115 that was being inspected. As shown in FIG. 2A, the forward moving direction of the magnet 101 was defined as the X-axis direction; the Y-axis was defined to be the direction perpendicular to the material 115. In the experiment, the magnet 101 was moved along the X-axis with a speed of about 1 cm/s. The embodiment of the magnet 101 in this experiment includes four cubic permanent magnets 109 having dimensions 1.27 cm×1.27 cm×1.27 cm, and two steel plates 111 with having thickness of 1.27 cm. The carbon steel bar 115 in this experiment had rectangular cross-section dimension of 2.54 cm×3.81 cm, which match the dimensions of the ferrite and martensite coupons used in this study. The carbon steel bar 115 has a gap for use to simulate the flaw 113. A flaw comprised of the ferrite or martensite phase was simulated by inserting the corresponding ferrite or martensite coupon into the gap 113 between the carbon steel bars. A crack or metal loss feature type flaw was simulated by leaving the gap at 113 location open. And the case of no flaw occurrence was simulated by having closing the gap 113 by pushing the carbon steel bars 115 together. The distance between the trailing sensor 105 and the magnet 101 is 2.54 cm. The distance of both center sensor and trailing sensor from the carbon steel bar is about 1 mm.

The cubic magnets 109 include a magnetic flux of about 0.7 Tesla at their pole surface. The two steel plates 111 are wide enough in order to reduce the amplitude of the magnetic flux density applied in a carbon steel bar 115. FIG. 2A shows the experimental equipment configuration with which the center sensor 103 was used to measure the magnetic response due to different types of flaws 113. such as the martensite phase and the metal loss or cracks (e.g., air gap).

Control experiments were performed, in which the device containing the magnet 101 was moved along the carbon steel bars 115, and the magnetic flux density was measured with sensors 103 and 105. In the first part of the control experiment, the gap 113 in the carbon steel bars was closed (i.e., in FIG. 2A, having the two ends of carbon steel bars 115 touching each other, so that there is no air gap between these two ends). In the second part of the control experiment, a ferrite coupon was inserted and fitted into the gap 113 between the two carbon steel bar ends. In both cases, the measured magnetic flux density only varies within 1 Gauss (0.0001 Tesla) because the magnetic property of the ferrite coupon is close to that of the carbon steel bar. Similar experiments were also carried out in which a martensite coupon was inserted and fitted into the gap 113 between the two carbon steel bar ends. The magnetic flux measured by sensor 103 is shown in FIG. 2B, which shows a pronounced peak in the presence of various air gaps and the martensite coupon. In addition, the height of the peak increases with the air gap thickness. Both ferrite and martensite coupons were faced, such that when these coupons are inserted into the gap 113, these coupons have good fit with minimal air gaps with the two carbon steel bars 115.

In accordance with at least one aspect of this disclosure, a method for determining one or more qualities of a sample composed of at least one hysteretic ferromagnetic material can include providing a DC magnetic field from a magnet to the hysteretic ferromagnetic material, receiving a first magnetic response at a first sensor disposed at a first location, receiving a second magnetic response at a second sensor disposed at a second location, and correlating both of the first magnetic and the second magnetic responses to one or more material qualities of the sample. A variation of this embodiment includes performing similar measurement on a hysteretic ferromagnetic material that has been degaussed. A DC magnetic field is a magnetic field that is not varying over time, and a degaussing magnetic field is a time-varying magnetic field that is used to eliminate residual magnetization of a material.

In accordance with at least one aspect of this disclosure, a non-transitory computer readable medium can be used to include instructions for performing a method. The method comprising recording magnetic responses from two or more suitable sensors disposed at locations with different magnetic field strengths in the regions of interest, and correlating all the said received magnetic responses to one or more material qualities of the said hysteretic ferromagnetic material. Correlating can include, but is not limited to, correlating all the said received magnetic responses to a material phase. Correlating can also include, but is not limited to, correlating all the said received, magnetic responses to a material flaw. A variation of this embodiment includes performing similar measurement on a hysteretic ferromagnetic material that has been degaussed. The method can include sending an indicator signal if the detected material quality deviates from the acceptable range of material quality. The method can also include sending an indicator signal in real time to remote user if the detected material quality deviates from the acceptable range of material quality. The method can also include recording an indicator signal for later retrieval or download for post-processing and follow-up actions if the detected material quality deviates from the acceptable range of material quality.

To quantify the relation between the received magnetic responses from the sensors and the air gap thickness, the peak magnetic flux versus the air gap thickness is shown in FIGS. 3A-3B. The experimental data and computer simulation results are shown in FIGS. 3,4 and 3B, respectively. FIG. 3A shows the experimental data of peak magnetic flux for the different thicknesses of air gap. The peak magnetic flux amplitude is the difference between the maximal magnetic flux in FIG. 2B and the averaged magnetic flux measured away from the flaw region. FIG. 3B shows computer simulation results for peak magnetic flux amplitude versus the air gap thickness. The computer simulation results are consistent with the experimental data as shown in FIG. 3A.

Both experimental data and computer simulation show the linear dependence of the magnetic flux peak as a function of the air gap thickness. Moreover, the numerically calculated slope of the linear dependence of magnetic flux peak versus air gap thickness agrees well with the experimental measurements. Both experimental measurements and computer simulations show that the relation between the magnetic response and the size of air gap (which simulates a. metal loss feature or a crack) is about 9 Gauss/100 μm. This excellent agreement between the experiment and computer simulation validates the simulation computer code.

In FIGS. 3A and 3B, the validity of computer simulation results for the magnetic flux density measurement of the center sensor 103 are demonstrated. Next, experiments and computer simulation were performed to validate computer code that simulates the magnetic measurements using both the center sensor 103 and the trailing sensor 105. These experiments and computer simulations are described in the following paragraphs.

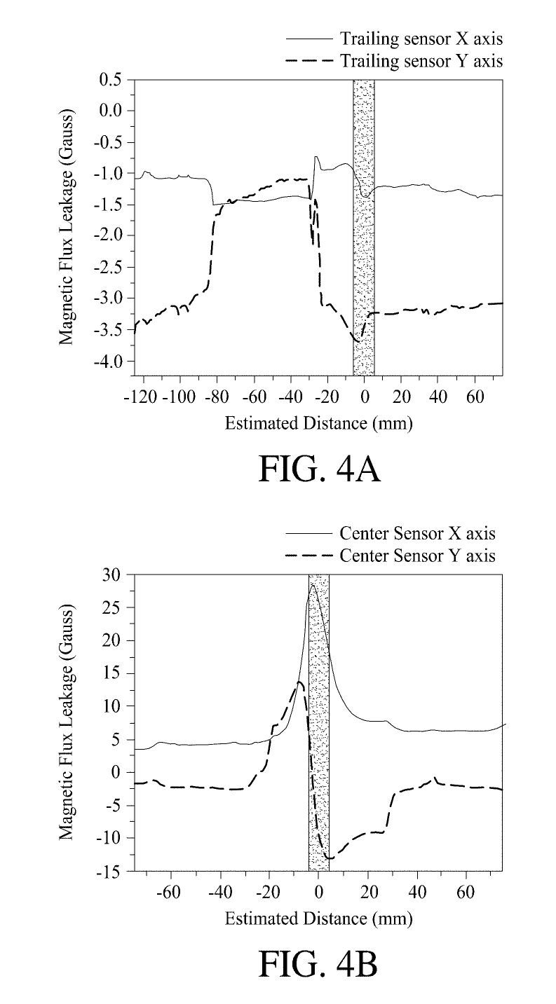

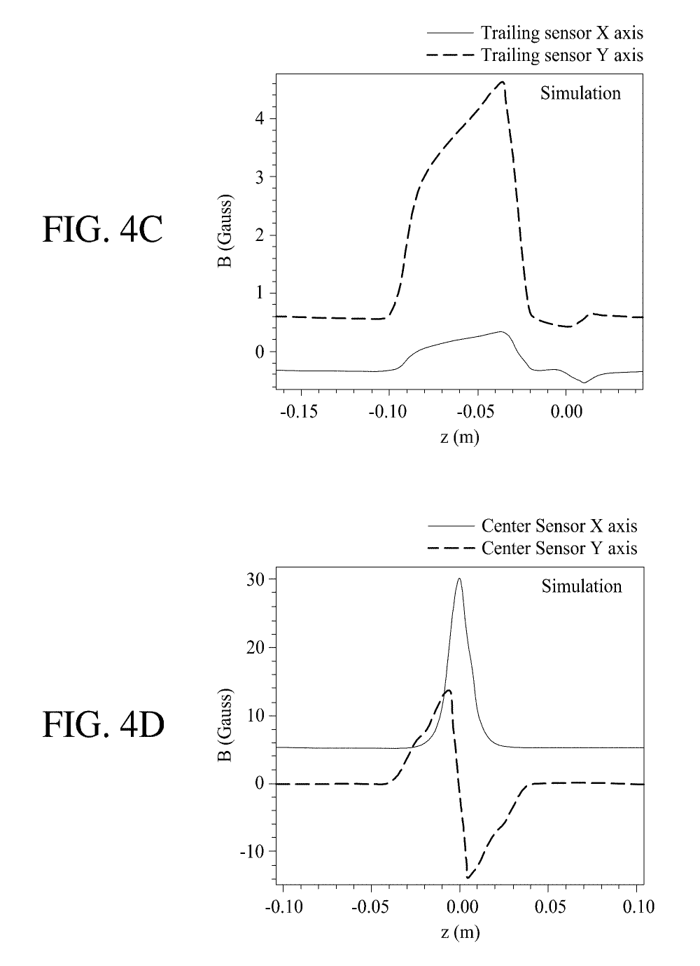

Referring to FIGS. 4A-4D, the magnetic flux density measured along the X-axis and Y-axis with a 308 μm air gap 113 is shown. The experimental results are shown in FIGS. 4A and 4B, and the computer simulation results are shown in FIGS. 4C and 4D. FIGS. 4A and 4C plot the magnetic flux density measured by the trailing sensor 105 and FIGS. 4B and 4D plot the magnetic to flux density measured by the center sensor 103. In FIGS. 4A-4D, the black curve shows the magnetic flux density along the X-axis, e.g., the moving direction of the permanent magnet 101, while the red curve shows the magnetic flux density along the Y-axis, e.g., the direction perpendicular to the surface of the material 115 (e.g., a carbon steel bar) as shown in FIG. 2A.

In both FIGS. 4A and 4C, the trailing sensor 105 are starting to detect a magnetic anomaly when the front of permanent magnet 101 reaches the location of the air gap. On the one hand, both the experiment and the computer simulation results show that the measured magnetic flux leakage there is a wide hump in the Y-axis trailing sensor 105. On the other hand, both the experiment and the computer simulation results show that the measured magnetic flux leakage along the X-axis is insensitive to the presence of the air gap, with only 0.5 Gauss magnetic anomaly.

The magnetic flux densities along the X-axis and Y-axis of the center sensor 103 are plotted in FIGS. 4B and 4D. Both the experiment and the computer simulation results show symmetric and relatively narrower magnetic responses along the X-axis but anti-symmetric and relatively wider magnetic responses along the Y-axis. The results in FIGS. 4A-4D show quantitative consistency between the experiment and simulation, which further validates the computer simulation code. Note that the baseline magnetic flux density measured in the experiment, the flat region in the responses, is different from the computer simulation, which is due to the unknown residual magnetic field in the carbon steel bar 115.

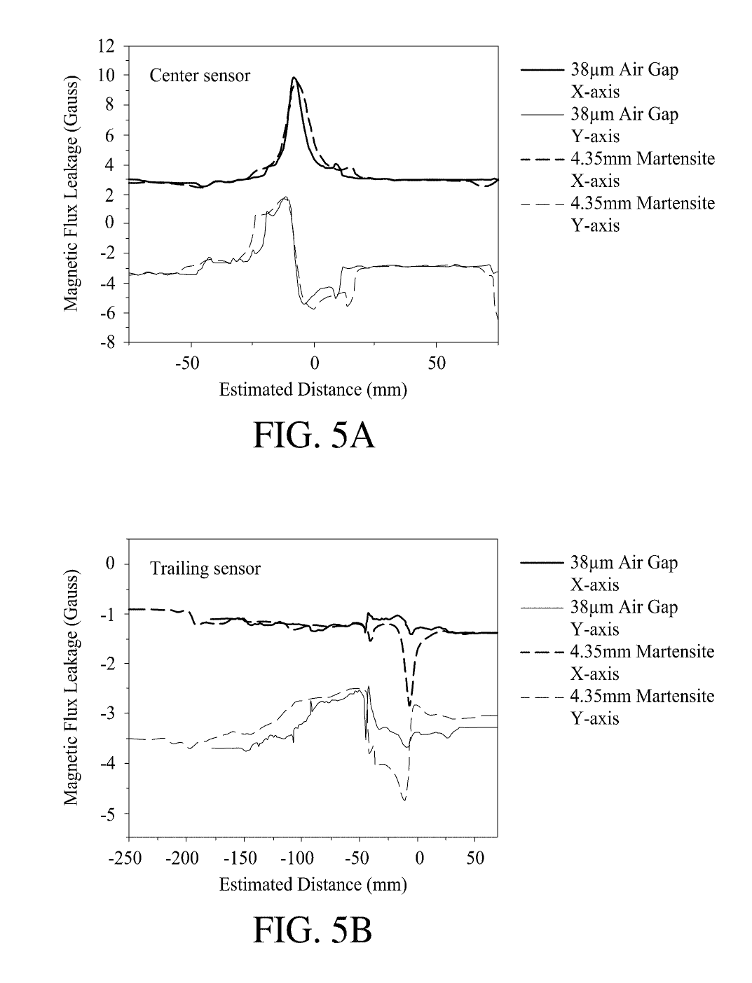

Using experimental setup shown in FIG. 2A, experiments were performed to measure magnetic flux leakage caused by a flaw 113, using center sensor 103 and trailing sensor 105, for the cases of using an air gap or a martensite coupon as the flaw. The experiment results are shown in FIGS. 5A and 5B. FIG. 5A shows the magnetic flux leakage measured by the center sensor 103. The solid curves correspond to the case with the 38 μm air gap as the flaw 113, and the dashed curves correspond to the case with the 4.35 mm hard martensite coupon as the flaw 113.

The measurement by the center sensor 103 probes the differences in the magnetic permeability between the flaws and the soft ferrite phases. Both the air gap and hard phases have a smaller magnetic permeability than soft ferrite phases. It has also been shown in FIGS. 3A and 3B that the magnetic anomaly is proportional to the size of the flaw. Therefore, the magnetic responses measured by the center sensor could show very similar signatures between the air gap and the hard phase. The results in FIG. 5A demonstrated the difficulties in distinguishing the hard phase from the corrosion metal loss or cracks if only using single point magnetic measurement.

In FIG. 5B, the magnetic responses measured by the trailing sensors, which show distinctive magnetic signatures between the air gap and the hard phase, are shown. Specifically, the X-axis magnetic flux density measured by the trailing sensor is insensitive to the presence of air gap while the same measurement in the presence of the martensite coupon experiences a significant dip that can be used as a distinguishing magnetic signature to identify the hard phase. In addition, the hard phase causes a trough and then a peak in the Y-axis magnetic flux density measurement around the location of the flaws as shown by the dashed green curve in FIG. 5B, whereas the magnetic response in the presence of air gap is rather flat near the location of the flaws. The dramatic differences in the magnetic responses measured by the trailing sensors between the air gap and the martensite phase can be due to the fact that the air gap is a linear magnetic material with a constant magnetic permeability while the magnetic permeability of the martensite phase is highly nonlinear and depends on the magnetic states that it experienced. Comparing FIGS. 5A and 5B, to distinguish the hard phase from the corrosion metal loss or crack, a multi-point sensing technique can be used that measures the magnetic properties of the materials at different points on the hysteresis loop.

After establishing the validity of the computer simulation tool as described above, by demonstrating the consistency between the results from experiments and computer simulations, in next step this computer simulation was used to demonstrate the feasibility of using the multi-point sensing and low magnetic flux technique for differentiating between the ferrite and the martensite/metal-loss-feature in a realistic pipe geometry.

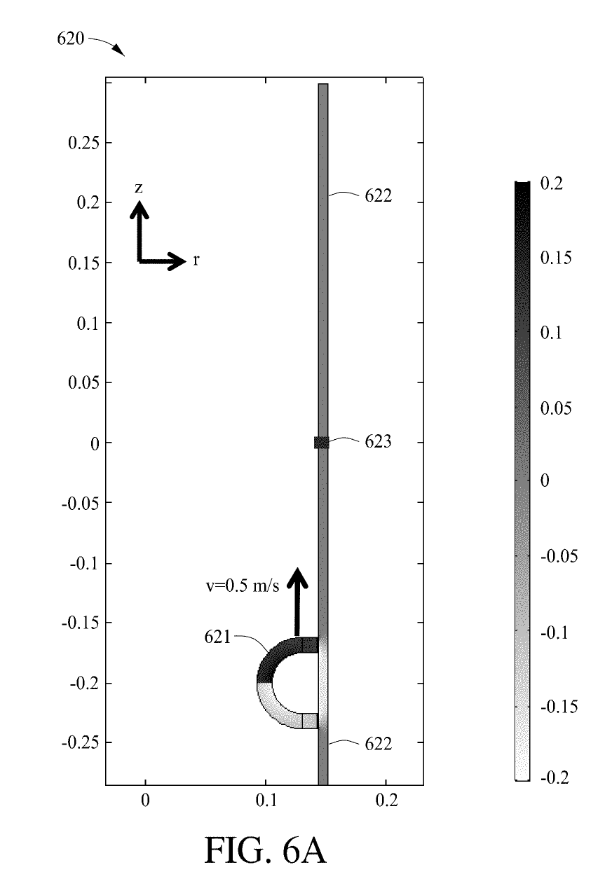

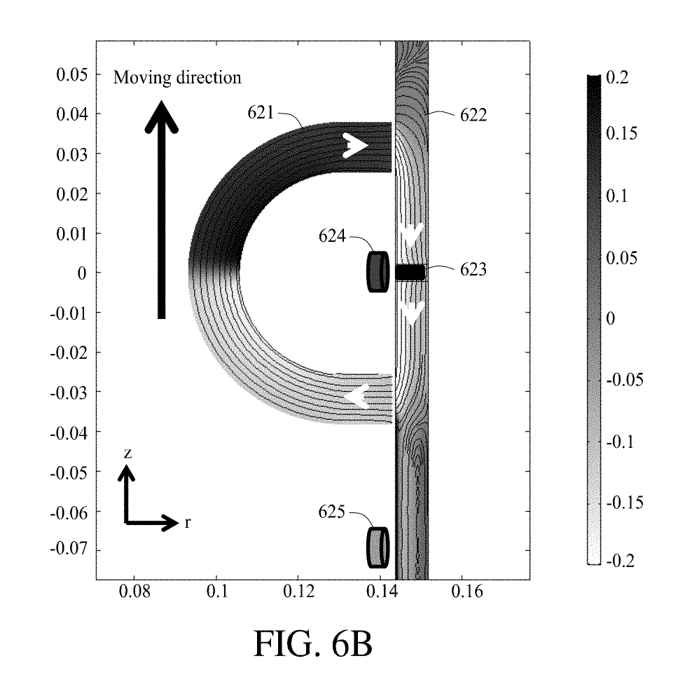

An embodiment of a geometry for the computer simulation is shown in FIGS. 6A-6B. The simulation was done for the axial symmetric geometry. FIG. 6A shows a schematic diagram of the system 620 with a horseshoe permanent magnet 621 moving along the pipe 622. The pipe 622 is axial symmetric with a radius of 15 cm and a thickness of 8 mm. The pipe 622 is made of soft ferrite phase except for a region 623 representing flaws in pipeline. The magnetic flux in the pipeline 622 is created by a horseshoe permanent magnet 621 on the left surface of the steel pipe wall, and is moving at a speed 0.5 m/s along the z-direction. There is a region 623 in the steel pipe wall at z=0, which denotes a flaw, such as the hard phase or the metal loss or crack.

FIG. 6B shows a close-up view of FIG. 6A when the horseshoe permanent magnet 621 passes over the martensite phase/air gap 623. In the figure, the lines in the horseshoe permanent magnet 621 and pipe 622 denote the magnetic flux lines obtained from computer simulation described below. Two sensors, the center sensor 624 and trailing sensor 625, are placed at a location 1 mm away from the pipe wall surface, and both move together along with the horseshoe permanent magnet during inspection. The z-distance between the center sensor and the trailing sensor is 7 cm.

As shown in FIG. 6B, the magnetic flux density is finite in the region below the horseshoe permanent magnet 621 due to the hysteretic response of magnetic materials. This difference between soft ferrite and hard martensite in the hysteretic response can be used in distinguishing these two phases. In addition, the magnetic flux measured by the trailing sensors enables differentiating the hard phase from the metal loss feature because of the non-hysteretic response of the latter.

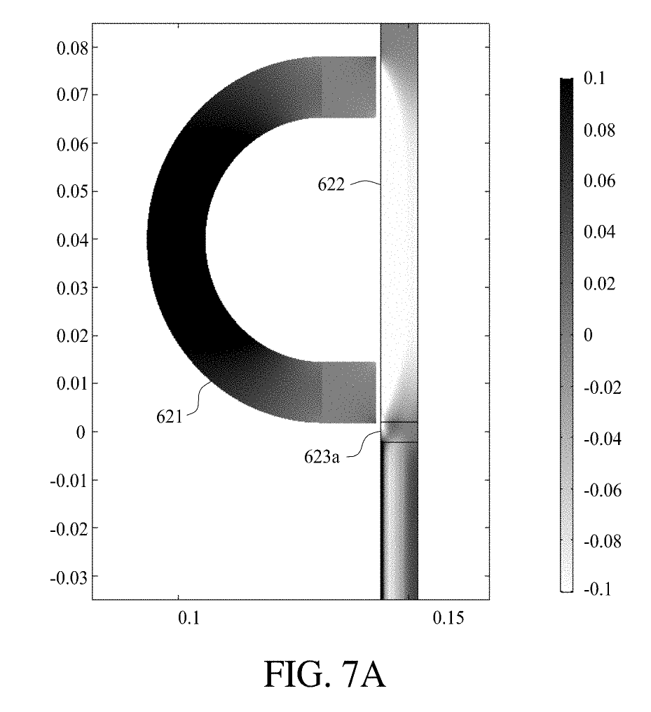

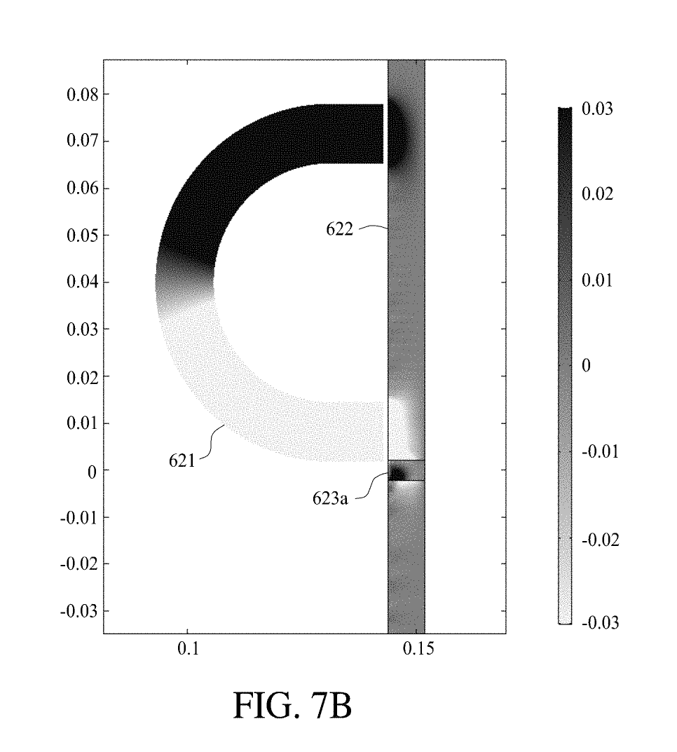

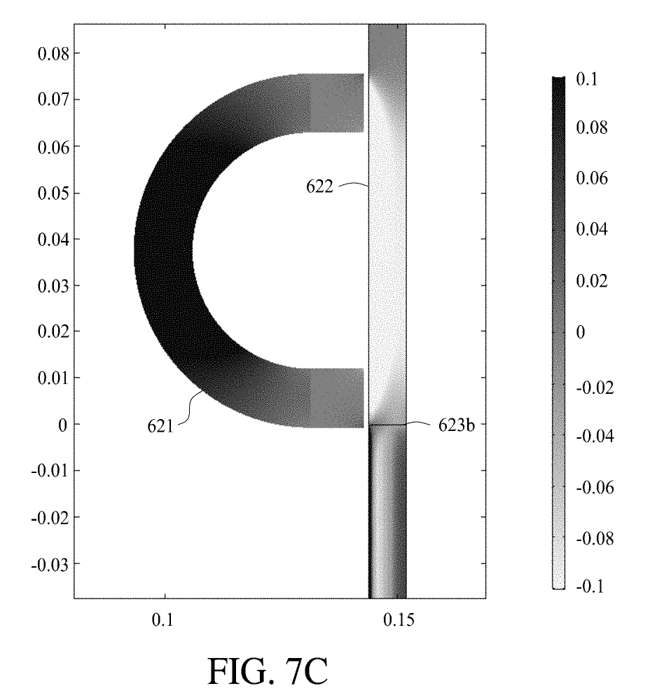

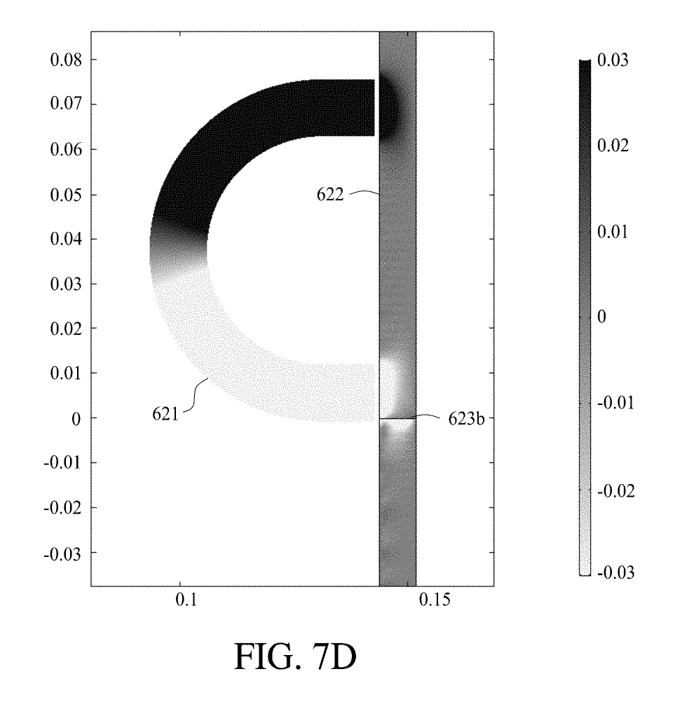

The COMSOL MULTIPHYSICS package was used to simulate the magnetic field strength when the horseshoe magnet 621 is moving vertically along the pipe wall at a speed of 0.5 m/s. FIGS. 7A-7D shows the spatially varying induced magnetic field when the permanent magnet 621 just passes the location of the flaws 623. FIGS. 7A and 7B correspond to the vertical z-component (Bz) and the horizontal r-component (Br) of magnetic flux density in the horseshoe magnet 621 and pipe wall in the presence of 4.35 mm martensite phase 623a, respectively. FIGS. 7C and 7D correspond to the vertical z-component (Bz) and the horizontal r-component (Br) of magnetic flux density in the presence of 38 μm air gap 623b, respectively.

The residual magnetic flux densities in the region below the location of the flaws show distinctive features between the hard phase 623a and the air gap 623b. This is due to the fact that the hard phase 623a is hysteretic whereas the air gap 623b is non-hysteretic. As a result, the trailing magnetic sensor can measure the different anomalous magnetic responses when passing through the martensite phase 623a or the air gap 623b.

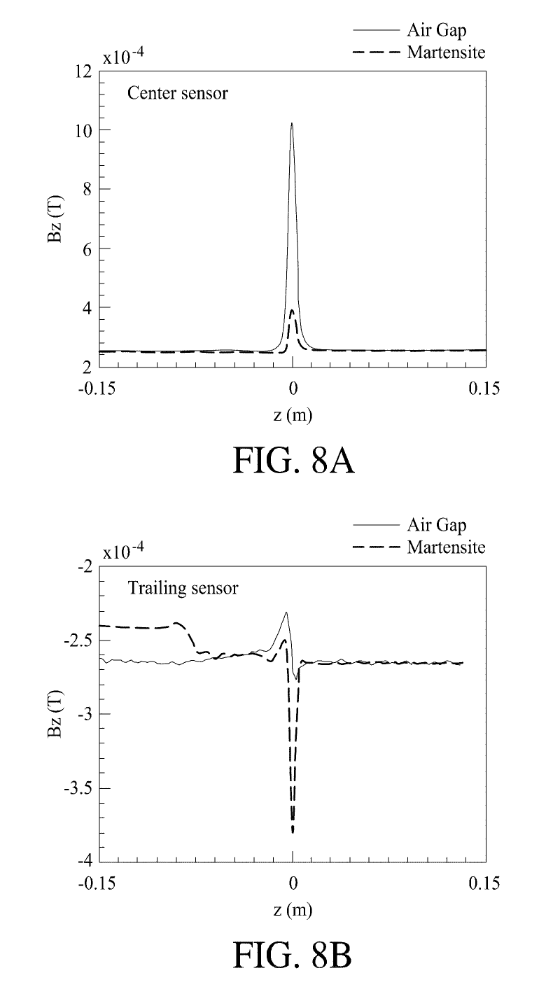

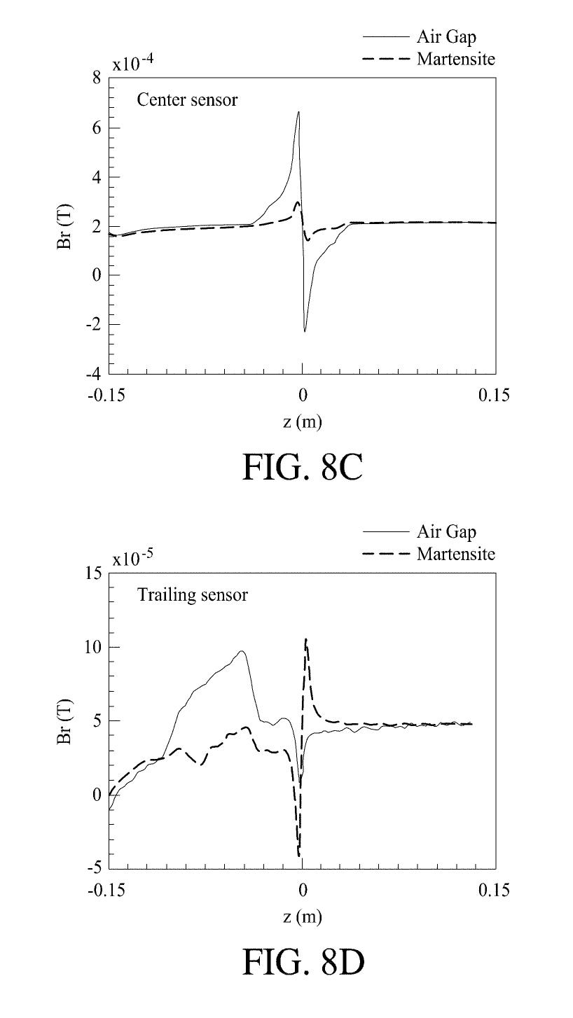

The simulated magnetic responses for martensite/air gap 623 detection are demonstrated in FIGS. 8A-8D. FIGS. 8A-8D plot the magnetic flux detected by the moving magnetic sensors. FIGS. 84 and 8B show a simulation of the vertical z-component (Bz) of magnetic flux measured by the magnetic sensor with maximum magnetic flux around 0.2 T in the pipeline. The results in FIGS. 8A and 8B correspond to the vertical-z-component (Bz) magnetic responses measured by the center sensor 624 and the trailing sensor 625, respectively. FIGS. 8C and 8D show the same simulation for the horizontal r-component of magnetic flux measured by the magnetic sensor. The results in FIGS. 8C and 8D correspond to the magnetic responses measured by the center sensor 624 and the trailing sensor 625, respectively. The solid curves show the simulation results in the presence of the air gap 623b while the dashed curves show results in the presence of the hard phase 623a. For the magnetic responses of the center sensor 624 shown in FIGS. 8A and 8C, both the air gap 623b and hard phase 623a give the magnetic anomaly in the measured magnetic response.

FIGS. 8A and 8C show that the air gap 623b and the martensite phase 623a induce qualitatively very similar features in the magnetic responses measured by the center sensor 624. The simulation results are consistent with the experimental measurement as shown in FIG. 5A. The hysteresis curve used in the computer simulation is slightly different from the real hysteretic properties of the martensite sample used in the experiment, In addition, the moving speed of the permanent magnet is about I cm/s in the experiment while the permanent magnet moves at 0.5 m/s in the computer simulation. These differences cause the quantitative differences between the experimental results and the simulation results when comparing FIG. 5A and FIGS. 8A/8C.

For the trailing sensor measurement as shown in FIG. 8B, the vertical-z-component magnetic anomaly in the presence of the hard phase 623a is more pronounced compared to that in the presence of air gap 623b. The sharp feature in the vertical-z-component magnetic flux density measured by the trailing sensor 625 due to the martensite 623a is consistent with our experimental data shown in FIG. 5B. Moreover, the magnetic measurement of the horizontal-r-component signifies the sharp difference between the air gap 623b and the hard phase 623a. Both vertical and horizontal components of the magnetic flux measured by the trailing sensor 625 show distinctive features between the air gap 623b and the martensite phase 623a. Therefore, incorporating multiple sensors in inline inspection can improve the reliability of detecting and differentiating the hard phase from the metal loss.

Both experimental and simulation results demonstrated the feasibility of multi-point sensing and low flux magnetic detection of the martensite phase. Moreover, the multi-point sensing technique makes it possible to detect and differentiate the hard phase from the metal loss.

As described above, embodiments can be applicable to differentiating various phases in steels used in pipelines, for example. Embodiments can also be used to identify metal loss and hard spots that are more prone to cracking and failure, which is an important component in pipeline integrity. Embodiments can enable detecting thin layers of a hard phase in steel plate mill inspection and differentiating hard spots from corrosion metal loss or crack. Embodiments of a method include extracting information from magnetic responses in steels under low magnetic flux modulation and measuring the strength of the magnetic field at different spots with multiple magnetic sensors.

The foregoing methods can be extended to the inspection of other steel components including, but not limited to, bolts, forgings, castings, and the like.

Embodiments utilize a multi-point sensing and low magnetic flux technique. The technique is based on the fact that soft and hard phases of steel (e.g., ferrite and martensite) experience different magnetic responses and hysteresis curves under low magnetic modulation. In addition, the use of a multi-point sensing technique allows measurement of magnetic to responses of materials at different points on hysteresis curves.

Embodiments enable more robust detection of hard phase in soft ferrite steels and make it possible to differentiate hard phases from corrosion metal loss or cracks using low magnetic flux. Embodiments are capable of extracting magnetic properties at multiple points on the hysteresis curve, which improves the traditional capabilities for differentiating various metallurgic phases and metal loss in steel. Based on extensive laboratory experimentation and computer simulations, it has been found that unique magnetic responses that can distinguish different hysteretic materials, such as soft ferrite steel and hard steel. In addition, this multi-point sensing and low magnetic flux devices and methods can be used to inspect real pipeline steel and identify hard spots or metal loss with high fidelity, whereas existing devices and methods are only designed to detect metal losses and have been proven to be unreliable in identifying flaws such as a hard phase.

In accordance with at least one aspect of this disclosure, embodiments can be used without limitation for detection of hysteretic magnetic material phases in nonhysteretic materials. Nonhysteretic materials can include, but is not limited to, aluminum, austenitic stainless steel, duplex stainless steel, and high manganese steel. Example of hysteretic magnetic material phases include, but are not limited to, at least one of martensite, epsilon martensite, ferrite, pearlite, bainite, lath bainite, acicular ferrite, and quasi-polygonal ferrite. A first example application of the detection of hysteretic magnetic material phases in nonhysteretic materials includes determining an amount of magnetic ferrite content in duplex stainless steels (DSS), which can be :30 used for grading the DSS or as a quality control measure. More specifically, the amount of delta ferrite in a ferrite-austenite DSS can be ascertained and used to grade the ferrite-austenite DSS or as quality control to determine if the amount of delta ferrite fall within desired range.

In yet another example, the detection of hysteretic magnetic material phases in nonhysteretic materials can be used for quality control when austenitic stainless steel (e.g., grades 304, 308, 316, and the like) weldments and austenitic stainless steel welds are exposed to high temperatures, for example, when refinery operating equipment such as piping, vessels, reactors, and weld overlays is exposed to hydrotreating conditions or hvdroprocessing conditions. Under such conditions, the sigma phase of ferrite (a hysteretic magnetic material phase) can form, which causes the material to become brittle. The methods and devices described herein can be used to measure the amount of or detect the presence or absence of the embrittling sigma phase of ferrite in all or portions of the refinery operating equipment. In hydrotreating, typically, the refinery operating equipment and welds thereof contain austenitic stainless steels. In hydroprocessing, typically, the refinery operating equipment downstream of the reactor contains to austenitic stainless steels, and the welds in refinery operating equipment upstream, in, and downstream of the reactor are contain austenitic stainless steels. The reactor in hydroprocessing is typically composed of Cr—Mo materials with austentic steel weld overlays. In some embodiments, the methods and devices described herein can also be used to measure the amount of or detect the presence or absence of ferrite content in girth and seam welds that are used for fabrication of austentic stainless steel piping, vessels and weld overlay of heavy wall Cr—Mo reactors in hvdroprocessing reactors in D/S. The amount of ferrite content needs to meet a desired amount for preventing weld solification cracking in stainless steel weldments.

In each of the foregoing examples of detecting hysteretic magnetic material phases in nonhysteretic materials, calibration samples can be prepared with different amounts of hysteretic magnetic material phases in nonhysteretic materials to correlate the magnetic flux density signal to the amount or content of the hysteretic magnetic material phases.

In accordance with at least one aspect of this disclosure, embodiments can be used without limitation for characterizing the hardness of welds. Similar to the disclosure regarding FIGS. 13A-E, the VHN or Brinell Hardness number (BHN) of different weld materials can be correlated to the magnetic flux density signal described herein. In a first example of applying the characterization the hardness of welds, a handheld device can be used to measure the magnetic flux density signal to welds (new, old, or repaired) or portions thereof, which can then be correlated to a VHN and/or a BHN.

Another example of applying the characterization the hardness of welds is to identify the type of electric resistance weld (ERW) (e.g., low-frequency heat-treated ERW, low-frequency non-heat-treated ERW, high-frequency heat-treated. ERW, and high-frequency non-heat-treated ERW). In this example, the magnetic flux density signal base pipe as compared to the magnetic flux density signal of the ERW can correlate to the type of ERW. Such correlation can be determined via standard calibration measurements. Implementation of such methods can be with in-line pipeline inspection gauges, automatic or manually pulled pipeline inspection tools, steel mill inspection tools, in-the-ditch inspection tools, handheld inspection devices, and the like. In yet another example of applying the characterization the hardness of welds is to identify the hardness of base pipe and the pipe grade using in-the-ditch inspection. In this example, the magnetic flux density signal can be calibrated and correlated to hardness, tensile and/or yield strength of the materials of base pipe. Such correlation can be used to determine the pipe grade using in-the-ditch inspection.

In yet another example of applying the characterization the hardness of welds, the hardness of welds (e.g., seam welds and/or girth welds) after repair. In one example, the repaired to welds may be associated with pressure vessels (e.g., composed of Cr—Mo ½Cr steels) used in hydrotreating and hydroprocessing reactors. The repair process can include removing the weld and a portions metal around the weld and replacing/patching the area. The newly formed welds can optionally be heat treated. The inspection process can include determining if the welds after repair (with or without post-weld heat treatment) meet industry standards and/or company specifications for the hardness of the weld and/or identify hard spots in the weld.

Another similar example includes measuring the hardness of welds associated with 21/4 Cr—V steel vessels. The inspection process can include determining if fabrication welds and/or welds after a repair (with or without post-weld heat treatment) meet industry standards and/or company specifications for the hardness of the weld and/or identify hard spots in the weld.

Yet another similar example includes management of weld hardness over time. That is, the vessels, pipes, and the like can be inspected over time monitoring the hardness and/or location and size of hard spots. Inspection can be carried out with any suitable device include handheld devices and automated crawlers. The inspection process can be performed on fabrication welds and/or repaired welds (with or without post-weld heat treatment).

In another embodiment of using the magnetic flux density signal correlated to weld hardness and/or hard spots in a weld, weld roots and/or weld caps specifically can be inspected and analyzed. In a preferred instance, this application can be applied to in-field welds of risers and sour service pipelines. Optionally, the inspection of root welds by the magnetic flux density signal methods/devices described herein can be conducted in combination with laser root profiling. Increased hardness in a root weld (e.g., a girth weld root) can originate from high cooling rates in an improper weld procedures (e.g., using Cu cooled shoes to close to the weld root) and/or dissolved Cu contamination in the weld metal from equipment such as Cu cooled shoes).

In yet another example of using the magnetic flux density signal correlated to weld hardness and/or hard spots in a weld, the quality of back welds can he assessed. Back welds are internal repairs to girth welds that are made manually. Determining the hardness and/or location and size of hard spots in a back welds can verify if the back weld meets the industry standards and/or company specifications for the hardness or determine if further repair is needed. Implementation of such methods can be with in-line pipeline inspection gauges, automatic or manually pulled pipeline inspection tools, handheld inspection devices, and the like.

In another example of using the magnetic flux density signal correlated to weld hardness and/or hard spots in a weld, methods and devices described herein can he used in to conjunction with welding bugs used to produce girth welds and/or ultrasonic testing bugs used to inspect girth welds. Bugs are automated machinery that moves around the circumference of a pipe to produce girth welds and/or inspect girth welds. The devices described herein can be incorporated with bugs to measure the magnetic flux density signal of the girth weld after being formed (i.e., with a welding bug) or when also measuring the ultrasonic response of the girth weld (i.e., with an ultrasonic testing bug).

In accordance with at least one aspect of this disclosure, embodiments can be used without limitation for characterizing the hardness, tensile strength, and/or yield strength of the material used to produce or in pipes or similar structures. Similar to the disclosure regarding FIGS. 13A-E, the hardness (e.g., VHN or BHN), tensile strength, and/or yield strength of different materials used to produce or in pipes or similar structures can he correlated to the magnetic flux density signal described herein. Once a hardness, tensile strength, and/or yield strength is determined, the pipe grade can be derived. Implementation of such methods can be with in-line pipeline inspection gauges, automatic or manually pulled pipeline inspection tools, steel mill inspection tools, in-the-ditch inspection, handheld inspection devices, and the like.

In accordance with at least one aspect of this disclosure, embodiments can be used without limitation for detecting and locating hard zones (e.g., cold worked areas or dents) that can cause stress corrosion cracking that lower the integrity of pipeline and similar structures. Stress corrosion cracking is the formation of or growth of a crack in a corrosive environment. In austenitic stainless steel and aluminum alloys, chlorides (e.g., NaCl, KCl, and MgCl₂) can be the source of stress corrosion cracking. Stress corrosion cracking typically start. with a small flaw in the surface that propagates under conditions where fracture mechanics predicts failure should not occur. Being able to detect stress corrosion cracking and or regions of local cold worked zones (hard zones) that can cause stress corrosion cracking with a nondestructive material inspection method or tool could mitigate the failure pipeline or other structures. Implementation of such methods can be with in-line pipeline inspection gauges, automatic or manually pulled pipeline inspection tools, handheld inspection devices, and the like.

As will be appreciated by those skilled in the art, aspects of the present disclosure may be embodied as a system, method or computer program product. Accordingly, aspects of the this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of this disclosure may take the form of a computer program product embodied in one or more computer readable medium(s) having to computer readable program code embodied thereon.

Any combination of one or more computer readable medium(s) may be utilized. The computer readable medium may be a computer readable signal medium or a computer readable storage medium.. A computer readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but is not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but is not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages, and visual programming languages, such as LabView, Igor or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, to including a local area network (LAN) or a wide area network (WAN), or the connection may be made to an external computer (for example, through the Internet using an Internet Service Provider).

Aspects of the this disclosure are described above with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

### Application of and Methods of Using Non-Destructive Material Inspection Systems

The methods and systems of the present disclosure, as described above and shown in the drawings, provide for nondestructive material inspection with superior properties. In one application, the methods and systems can be used as a nondestructive evaluation tool for in-line-inspection to identify one or more anomalies, flaws, and qualities in material being inspected. Examples of materials being inspected include, but are not limited to, steel plates, bolts, forgings, castings, pipes, risers, surfaces, welds, weld roots, weld caps, joints, and the like. Examples of anomalies, flaws, and qualities in samples that can be detected using the systems, devices, and method of the present invention include, but are not limited to, the hardness of welds and changes therein, the hardness of the material and changes therein used to produce or in pipes or similar to structures, the grade of the material used to produce or in pipes or similar structures, the type of weld, the hardness of the material and changes therein, the presence of a material phase in the material (e.g., the presence of a hard steel phase such as martensite or bainite in carbon steel, nonhysteretic material phases in hysteretic ferromagnetic materials and hysteretic magnetic material phases in nonhysteretic materials), the presence of hard spots in the material, the presence of metal loss or cracks in the material (e.g., stress corrosion cracks), the presence of defects in the material, and combinations thereof.

In the above mentioned applications, the material phase can include, but is not limited to, at least one of austenite, martensite, ferrite, pearlite, bainite, lath bainite, acicular ferrite, and quasi-polygonal ferrite. In certain embodiments, the device can be incorporated onto nondestructive evaluation tools for detecting one or more material qualities of a sample composed of at least one hysteretic ferromagnetic material. Non-limiting examples of the nondestructive evaluation tools include in-line pipeline inspection gauges, automatic or manually pulled pipeline inspection tools, steel inspection tools, and handheld inspection devices.

In certain embodiments, the application can include, but is not limited to, multiple copies of a magnet and two or more suitable sensors placed at a preferred nearby location of the sample.

In certain embodiments, the application can include, but is not limited to, a computer-controlled automatic moving platform to move the magnet and the two or more suitable sensors to detect magnetic responses at different spatial locations. In certain embodiments, the application can include, but is not limited to, a manually controlled translating and rotating platform to move the magnets and the two or more suitable sensors to detect magnetic responses at different spatial locations. In certain embodiments, the application can include, but is not limited to, a handheld device that includes at least one magnet and two or more suitable sensors. In certain embodiments, the sample in the application can include, but is not limited to, low-frequency heat-treated ERW pipes, low-frequency non-heat-treated ERW pipes, high-frequency heat-treated ERW pipes, and high-frequency non-heat-treated ERW pipes.

Further details of four particular applications of and methods of using non-destructive material inspection systems are as follows:

### 1. Steel Component Inspection

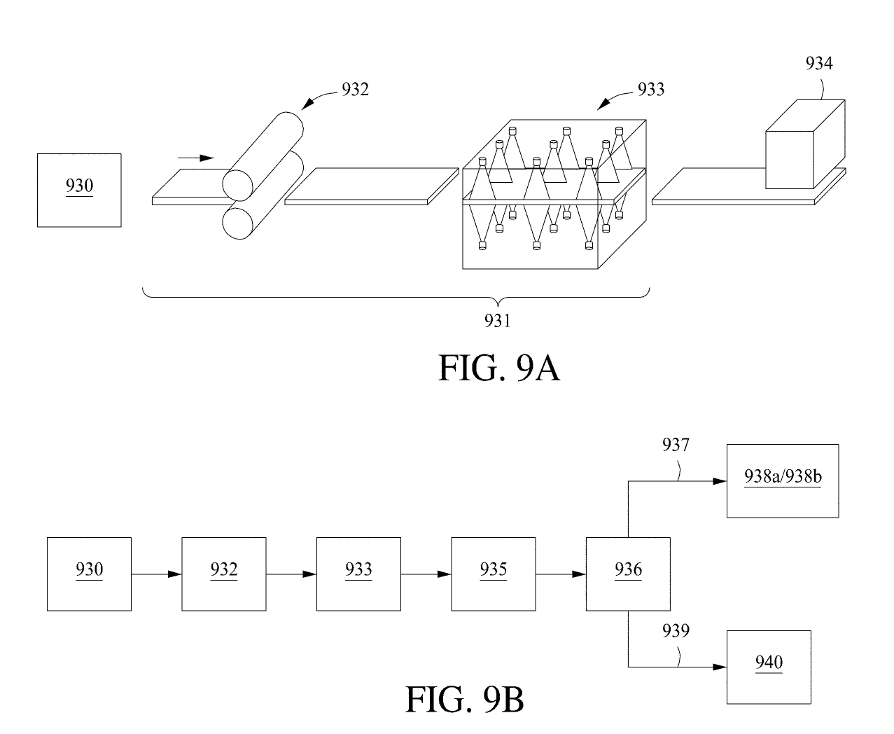

Referring now to FIGS. 9A and 9B, there is a need to non-destructively examine steel components like steel plates that are fabricated into a line pipe for pipeline or down hole applications for undesirable phases such as hard metallurgical phases (for example: martensite or lath bainite) that degrade the performance and decreases the life of pipelines or tubulars in to service. Large diameter line pipes are typically manufactured from hot rolled steel plates using the Thermo-Mechanical Controlled Processing (TMCP) method 931 after which they are cold formed into “U” shape followed by “O” shape in a die and expanded into pipe after long seam welding (U OE) or press bended sequentially into “J”, “C” and “O” shapes (JCO) after which they are long seam welded and expanded to the final shape and dimensions. The long seam weld is typically made by submerged arc welding (SAW), double submerged arc welding (DSAW) or electric resistance welding process (ERW). During the manufacturing of the TMCP plate there can be process upsets in any of the following steel processing steps (as shown in FIG. 9A) such as ingot or continuous casting process 930, hot rolling 932, and accelerated cooling (ACC) 933 leading to the formation of undesirable phases on the surface (or in the bulk) of the TMCP steel plate. There is a need for a non-destructive inspection technique that can enable process and quality control of the TMCP plate manufacturing to inspect or screen for the undesirable phases. In one embodiment it is envisioned that the above disclosed magnetic detection methods and systems are incorporated in an inspection device 934 capable of scanning the TMCP plate surface after the accelerated cooling step 933 as shown in FIG. 9A and FIG. 9B. This inspection device 934 can scan/inspect 935 the plate manually using a trolley or on an automated scanning system. The data from the scan is analyzed online or stored and analyzed offline to determine 936 whether there are undesirable phases present in the steel plate and whether the amount of undesirable phases are above a predetermined threshold (for example, formation of hard microstructural zones on the plate surface). If the amount of undesirable phases are above 937 the threshold, the plate is rejected 938a from further processing into a line pipe or remediated 938b by suitable metallurgical treatments (for example tempering) before it is further processed into a. line pipe. If the amount of undesirable phases are below 939 the threshold, the plate is further processed 940 into a line pipe. Such an inspection 935 of plates after the ACC step will provide feedback to the steel and plate processing steps to optimize the process for minimizing the formation of undesirable phases.

In the above mentioned application, examples of undesirable phases can include, but are not limited to, at least one of martensite, bainite, lath bainite, and any nonhysteretic material. The material phases in the steel plate can include, but are not limited to, at least one of austenite, martensite, ferrite, pearl.ite, bainite, lath bainite, acicular ferrite, and quasi-polygonal ferrite. The inspection device 934 for the above mentioned application can include, but is not limited to, multiple copies of device 100 and multiple copies of magnets and magnetic sensors placed at a preferred nearby location of the steel plate. Each magnet can be paired with two or more copies of magnetic sensors. Additionally, the inspection device 934 can include, but is not limited to, a. computer-controlled automated moving platform or a manually controlled moving platform such as a trolley for moving the magnets and magnetic sensors to detect magnetic response at different spatial locations.

In certain embodiments, the inspection device 934 can include, but is not limited to, at least one or more magnets, and at least one of magnetic sensors located at the center of the magnets, and at least one of magnetic sensors located at the trailing side of the magnets.

The foregoing methods can be extended to the inspection of other steel components including, but not limited to, bolts, forgings, castings, and the like.

### 2. Steel Pipeline Seam Weld Inspection

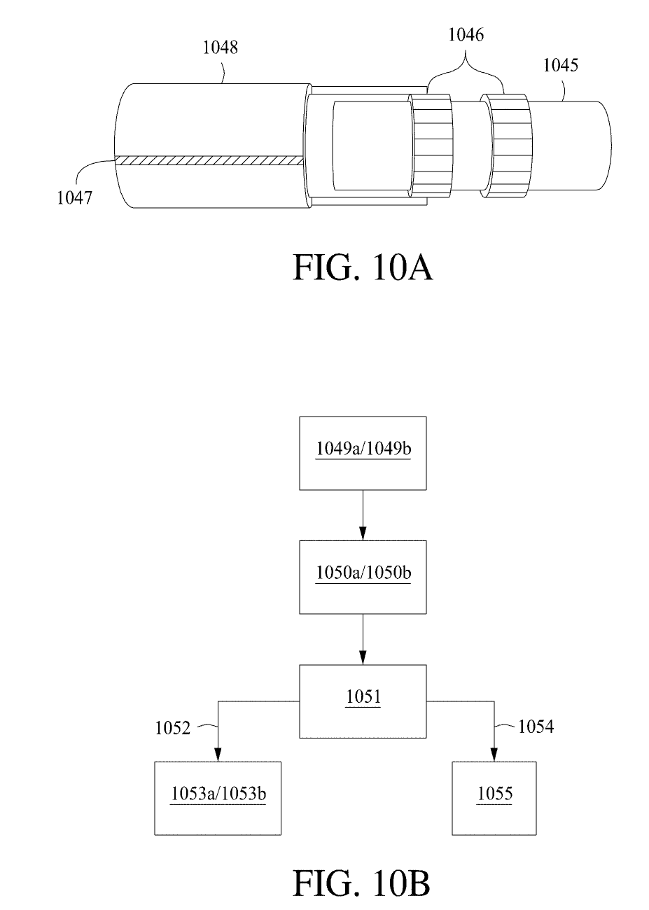

Referring now to FIGS. 10A and 10B, there is also a need to non-destructively examine steel pipelines 1048 for assessing pipeline integrity for undesirable phases such as hard metallurgical phases (for example: martensite or lath bainite) that degrade the performance and decreases the life of pipelines or tubulars in service. Large diameter line pipes 1048 are typically manufactured from hot rolled steel plates using the TMCP method after which they are cold formed using JCO or UOE processes into the final shape and dimensions. The long seam weld 1047 is typically made by submerged arc welding (SAW), double submerged arc welding (DSAW) or electric resistance welding process (ERW). Both large and small diameter line pipes 1048 can also be manufactured from hot rolled strip and continuously cold bent and welded using a suitable long seam welding process to make line pipes 1048. The long seam welding employed can be high frequency ERW (HF-ERW) for modern line pipes or it can be either low frequency ERW (LF-ERW) or HF-ERW or flash-butt weld or similar processes for vintage line pipes that were manufactured pre-1970s. During manufacture of line pipe 1048 in the steel mills there can be process upsets during the long seam welding process or post-welding heat treatment (PWHT) of the long seam weld. For example, long seam welds 1047 in pre-1970's vintage pipe 1048 made by ERW contain heat affected zone (HAZ) that are typically 2 to 10 mm wide and across from inside diameter (ID) to outside diameter (OD), Undesirable phases such as hard metallurgical phases could form both at the bond line and or in the HAZ. If the weld 1047 was not heat treated or, improper post weld heat treatment process during pipe manufacture can leave undesirable phases such as hard metallurgical phases in the line pipe seam weld 1047 and they can then be subsequently installed in service. Therefore, for the pipelines 1048 that are currently in service, there is a need for a non-destructive inspection technique that can assess the threat for the integrity of pipelines 1048 by inspecting or screening for the undesirable phases with minimum interruption to the flow of product (e.g., crude oil, natural gas, gasoline etc.) in the pipe to 1048. In one embodiment, the above disclosed magnetic detection methods and systems are incorporated in one or more inspection devices 1046 on a pipeline inspection gauge (PIG) 1045 capable of inspecting or scanning the ID of the pipe as shown in FIG. 10A. During the inspection, the PIG 1045 is sent through the pipeline 1048 and the onboard inspection devices 1046 perform data acquisition and collection 1049a, (and/or initial analysis), and store 1049b the measurement results. At the pipeline outlet or PIG receiver location, the users retrieve 1050a the PIG 1045 and download the stored data, which can be further analyzed and post-processed 1050b (e.g., in another computer) to determine 1051 whether there are undesirable phases present in the pipeline, the locations of the undesirable phases, and whether the amount of undesirable phases are above a predetermined threshold value. If the amount of undesirable phases are above 1052 the threshold value at a specific location, the pipeline segment 1048 at that location may be replaced 1053a or remediated 1053b by suitable metallurgical treatments (for example tempering or annealing) as in the flow chart FIG. 10B. If the amount of undesirable phases are below 1054 the threshold value at a specific location, the pipeline 1048 remains 1055 in service.

In the above application, examples of undesirable phases can include, but are not limited to, at least one of martensite, bainite, lath bainite, and any nonhysteretic material. The material phases in the pipeline 1048 can include, but are not limited to, at least one of austenite, martensite, ferrite, pearlite, bainite, lath bainite, acicular ferrite, and quasi-polygonal ferrite. The inspection device 1046 for the above mentioned application can include, but is not limited to, multiple copies of device 100 and multiple copies of magnets and two or more magnetic sensors located at preferred nearby locations of the ID of the pipe wall. Each magnet can be paired with two or more copies of magnetic sensors. In certain embodiments, multiple copies of the inspection devices 1046 are placed in an arrangement to cover the circumference of the PIG 1045 at one or more longitudinal locations (two locations as shown on FIG. 10A). A preferred arrangement includes at least 20 copies of the inspection devices 1046 around the circumference per one longitudinal location. A more preferred arrangement includes at least 100 copies of the inspection devices 1046 around the circumference per one longitudinal location. An even more preferred arrangement includes maximum number of inspection devices 1046 that could densely packed around the circumference per one longitudinal location.

In certain embodiments, the inspection device 1046 can include, but is not limited to, at least one or more horseshoe magnets with their two legs contacting the ID of the pipe wall, and at least one of magnetic sensors located at the center of the horseshoe magnet, and at least one of the magnetic sensors located at the trailing side of the horseshoe magnet.

### 3. Inspection of Welds in Pipeline, Risers, Piping and Welded Structures

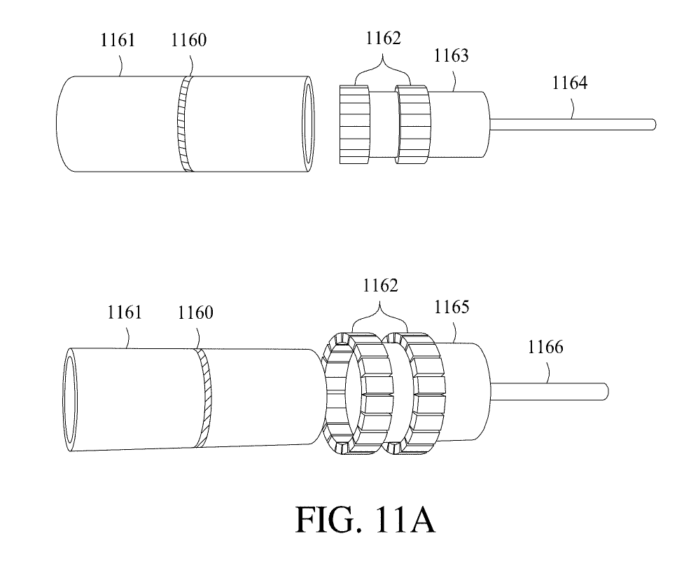

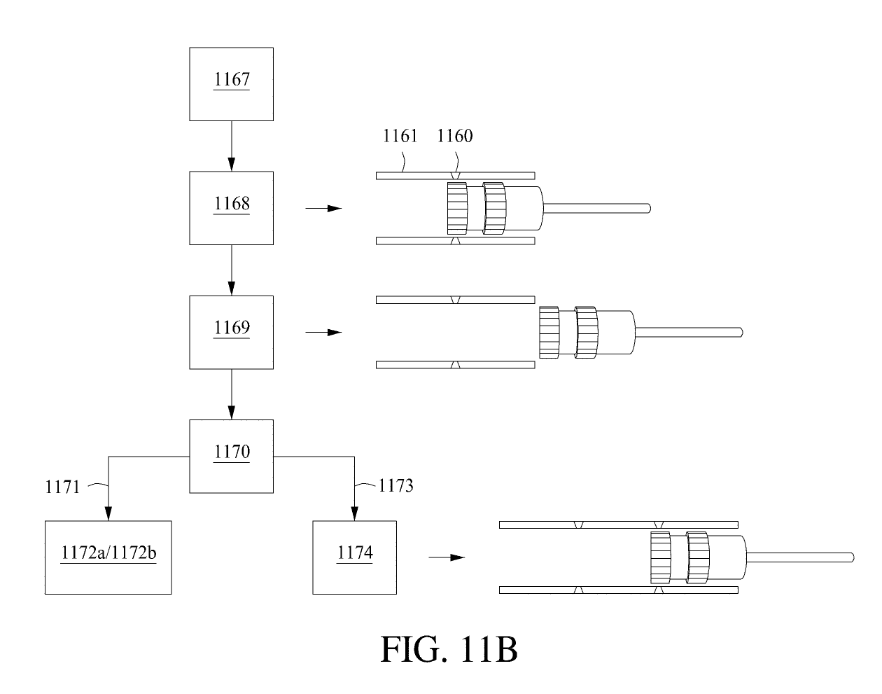

Referring now to FIGS. 11A and 11B, there is also a need to non-destructively inspect welds such as girth welds 1160 in risers, pipelines 1161, and other piping systems or fillet or lap or butt welds in piping and welded structures for undesirable phases such as hard metallurgical phases (for example: martensite or lath bainite) that can degrade the performance and decreases the life of risers, pipelines 1161, tubulars, piping or welded structures in service. During the construction phase of risers, pipelines 1161, and other piping systems, sections of piping or line pipe 1161 are typically joined/welded together along the circumference to make up continuous or long sections of piping or pipelines or risers and this is called a girth weld 1160. Similarly, during construction of piping systems or structures with welded joints, typically used weld types include but not limited to girth welds 1160, fillet welds, lap welds, or butt welds. The different types of welds are typically made by welding processes 1167, including but not limited to, Gas Metal Arc Welding (GMAW), Shielded Metal Arc Welding (SMAW), Gas Tungsten Arc Welding (GTAW), or Flux-Cored Arc Welding (FLAW). There can be process upsets during these welding processes 1167, and undesirable/deleterious phases such as hard metallurgical phases could form in the girth weld 1160 (for example at the root of a girth weld in the ID, at weld cap of a girth on the OD) and require remediation during the construction of the pipeline, riser, or piping system, or welded structure. As a result, there is a need for a non-destructive inspection technique that can enable process and quality control of the girth weld 1160 to inspect/screen for the undesirable phases. In one embodiment, the above disclosed magnetic detection methods and systems are incorporated in one or more inspection devices 1162 on a manual (e.g., tethered or pulled system) or automatic (e.g., robotic crawler) inspection tool capable of inspecting/scanning the ID, or a manual or automatic system for the inspection of OD of the pipe, or the cap of a structural or piping weld. An example of an ID inspection tool 1163 for scanning the root of the girth weld 1160 is shown in FIG. 11A. An example of an OD inspection tool 1165 for scanning the girth weld 1160 is also shown in FIG. 11A. After the construction of one girth weld 1160 between two line pipe sections, or after deposition of the root pass or root, and hot passes or root, hot and a few fill passes, and before proceeding to the next girth welding, or completing the current weld in the case of inspection after partially completed girth weld 1160, the ID inspection tool 1163 may be pushed 1168 into the pipe so that the onboard inspection devices 1162 reach the preferred nearby location of the girth weld 1160 from pipe ID and then perform data acquisition and analysis. The users then retrieve 1169 the ID inspection tool (e.g., with a tether 1164 for the ID inspection tool 1163 or with a tether 1166 for the ID inspection tool 1165) and the data is analyzed 1170 online by the onboard computer to determine whether there are undesirable phases present at the root of the girth weld, the locations to of the undesirable phases, and whether the amount of undesirable phases are above a predetermined threshold. If the amount of undesirable phases are above 1171 a threshold value, the girth weld is then removed/cut-out and replaced 1172a with a new girth weld or rernediated 1172b by suitable treatments such as applying a temper beading technique for the next weld pass (e.g., after the root pass or root and hot pass at the ID) or post weld heat treatment (e.g., tempering or normalizing) before proceeding to the next girth weld as in the flow chart FIG. 11B. If the amount of undesirable phases are below 1173 a threshold value, the inspection tool 1163 can proceed to the next girth weld 1174.

In the above mentioned application, examples of undesirable phases can include, but are not limited to, at least one of martensite, bainite, lath bainite, and any nonhysteretic material. The material phases in the pipeline can include, but are not limited to, at least one of austenite, martensite, ferrite, pearlite, bainite, lath bainite, acicular ferrite, and quasi-polygonal ferrite. The inspection device 1162 for the above mentioned application can include, but is not limited to, multiple copies of device 100 and multiple copies of magnets and two or more magnetic sensors located at preferred nearby locations of the ID or OD of the pipe wall or welds in piping or welded structures. Each magnet can be paired with two or more copies of magnetic sensors. In certain embodiments, multiple copies of the inspection devices 1162 are placed in an arrangement to cover the circumference of the pulled inspection tool 1163, 1165 at one or more longitudinal locations (two locations as shown on FIG. 11A). A preferred arrangement, includes at least 20 copies of the inspection devices 1162 around the circumference per one longitudinal location. A more preferred arrangement, includes at least 100 copies of the inspection devices 1162 around the circumference per one longitudinal location. An even more preferred arrangement, includes maximum number of inspection devices 1162 that could be densely packed around the circumference per one longitudinal location.

In certain embodiments, the inspection device 1162 can include, but is not limited to, at least one or more magnets contacting the ID or OD of the pipe wall, and at least one of magnetic sensors located at the center of the magnets, and at least one of magnetic sensors located at the trailing side of the magnets.

### 4. Handheld Inspection of Steel Components, Pipeline Seam and Girth Welds, Welds in Piping, and Welded Structures

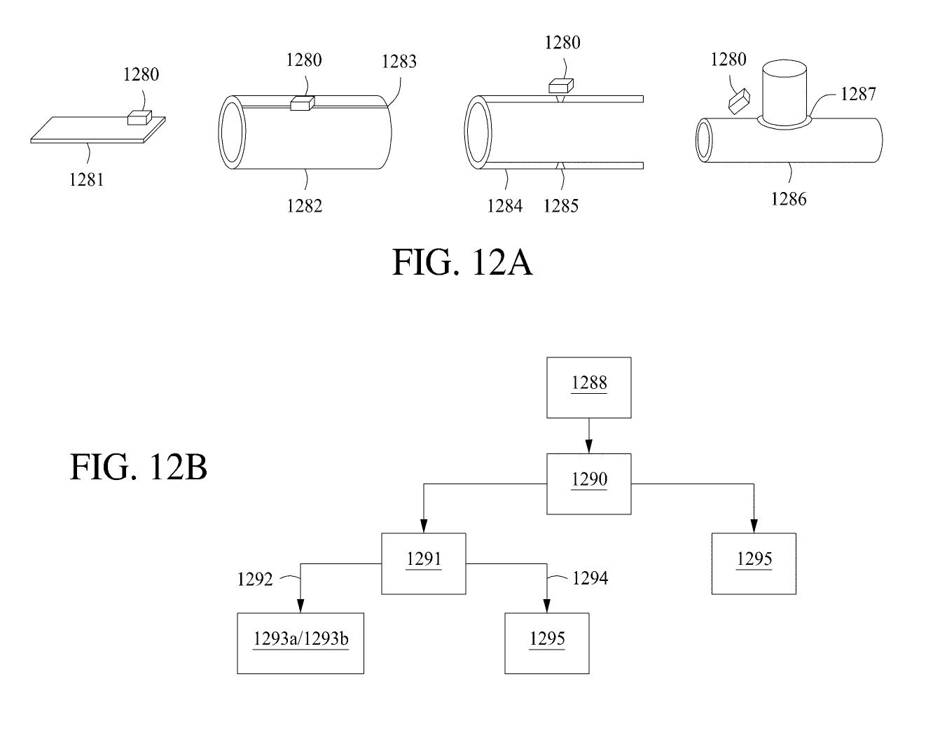

Referring now to FIGS. 12A and 12B, there is a need to non-destructively examine steel materials and welds such as steel plate 1281 (or other steel component like bolts, forgings, and castings), seam weld 1283 in a pipe 1282, girth weld 1285 in a pipe 1284, fillet weld 1287 to a pipe 1286, butt weld, and lap weld with a handheld inspection tool 1280 for undesirable phases such as hard metallurgical phases (for example: martensite or lath bainite) that degrade the performance and decreases the life of pipelines, tubulars, piping, or welded structures in service. There is also a need to identify the seam type and heat treatment state by non-destructive examination for pipelines that are already in service. Large diameter line pipes are typically manufactured from hot rolled steel plates using the TMCP method after which they are cold formed using ICO or UOE processes into the final shape and dimensions. During the manufacturing of the TMCP plate, there may be process upsets in any of the following steel processing steps (as shown in FIG. 9A) such as ingot or continuous casting process 930, hot rolling 932, and accelerated cooling (ACC) 933 leading to the formation of undesirable phases on the surface (or in the bulk) of the TMCP steel plate. There can also be process upsets during the long seam welding process such as ERW, SAW, or DSAW, or during post-welding heat treatment (PWHT). Both larger and small diameter line pipes can also be manufactured from hot rolled strip, continuously cold bent, and welded using a suitable long seam welding process to make line pipes. The long seam welding employed can be high frequency ERW (HF-ERW) for modem line pipes, it can be either low frequency ERW (LF-ERW), HF-ERW, flash-butt weld, or similar processes for vintage line pipes that were manufactured pre-1970's. During manufacture of line pipe in steel mills, there may be process upsets during the long seam welding process or post-welding heat treatment (PWHT) of the long seam weld. For example, long seam welds in pre-1970's vintage pipe made by ERW include a heat affected zone (HAZ) that are typically 2 to 10 mm wide and across from inside diameter (ID) to outside diameter (OD). Undesirable phases such as hard metallurgical phases could form both at the bond line and or in the HAZ, If the weld is not heat treated or is an improper post weld, heat treatment process during pipe manufacture can leave the undesirable phases such as hard metallurgical phases in the line pipe and they are then subsequently installed in service. During the construction phase of risers, pipelines and other piping systems, sections of piping or line pipe are typically joined/welded together along the circumference to make up continuous or long sections of piping or pipelines or risers. This is called a girth weld. Similarly, during construction of piping systems or structures with welded joints, typically used different weld types include, but are not limited to girth welds, fillet welds, lap welds, or butt welds. The different types of welds are typically made by welding processes including but not limited to Gas Metal Arc Welding (GMAW), Shielded Metal Arc Welding (SMAW), Gas Tungsten Arc Welding (GTAW), or Flux-Cored Arc Welding (FCAW).

During all the above mentioned processes, phases such as hard metallurgical phases may form in the steel plate 1281, in the seam weld 1283, or in the girth weld 1285, and under some service conditions (e.g., wet H₂S service or sour service) and they can be deleterious. There is a need for a non-destructive inspection technique to inspect/screen for microstructural phases such as hard microstructures or weld type such as whether a line pipe seam weld is a LF-ERW or HF-ERW weld and whether the weld was heat treated or not. In one embodiment, the above disclosed magnetic detection methods and systems are incorporated in a handheld inspection device 1280 capable of inspecting/scanning various metals including carbon steel materials as shown in FIG. 12A. In one embodiment, a user can use the handheld tool 1280 to scan 1288 the TMCP plate 1281 surface after the accelerated cooling step or at any stage after that, in another embodiment, a user can use the handheld tool 1280 to scan 1288 the girth welds 1283 from the OD of the pipeline 1282 either during the pipeline1282, riser, piping construction, after its completion, or after many years in service. In another embodiment, a user can use the handheld tool 1280 to scan 1288 the girth welds 1285, fillet welds 1287, lap joints, butt welds of piping or welded structures 1284, 1286 during construction, after its completion, or after many years in service. In yet another embodiment, the user can use the handheld tool 1280 to scan 1288 pipeline and its seam weld 1283, and identify ERW welding types including, but are not limited to, LF-ERW heat-treated pipes, LF-ERW non-heat-treated pipes, HF-ERW heat-treated pipes, and HF-ERW non-heat-treated pipes. During all the inspection processes, the data from the scan are analyzed 1290 online or off-line to determine 1291 whether there are undesirable phases present in the corresponding steel materials, the locations of the undesirable phases, and whether the amount of undesirable phases are above a predetermined threshold level. If the amount of :30 undesirable phases are above 1292 the threshold value at a specific location, the steel materials at that location require replacement 1293a or remediation 1293b by suitable treatments, for example tempering as shown in the flow chart of FIG. 12B. If the amount of undesirable phases are below 1294 the threshold value at a specific location, the steel materials remain in service. In another mbodiment, the data from the scan is analyzed 1296 either online or offline to determine the seam type and whether the weld was post weld heat treated or not for vintage pipelines.

In the above mentioned applications, examples of undesirable phases can include, but are not limited to, at least one of martensite, bainite, lath bainite, and any nonhysteretic material. The material phases in the steel materials can include, but are not limited to, at least one of austenite, martensite, ferrite, pearlite, bainite, lath bainite, acicular ferrite, and quasi-polygonal ferrite. The handheld inspection device 1280 for the above application can include, but is not limited to, multiple copies of device 100 and multiple copies of magnets and two or more magnetic sensors, and during a scan the magnets and sensors are placed at a preferred nearby to location of the steel materials. Each magnet can be paired with two or more copies of magnetic sensors.

In certain embodiments, the inspection device 1280 can include, but is not limited to, at least one or more magnets contacting the surface of the steel materials, and at least one of magnetic sensors located at the center of the magnets, and at least one of magnetic sensors located at the trailing side of the magnets.

### Example Embodiments

A first example embodiment is a method of utilizing a nondestructive evaluation method to inspect/screen a steel component (e.g., steel metal plates, bolts, forgings, castings, and the like)composed of at least one hysteretic ferromagnetic material to identify material phases and/or material qualities of the component comprising the steps of: providing a DC magnetic field from a magnet to a steel component composed of at least one hysteretic ferromagnetic material; scanning the steel component and recording magnetic responses from two or more suitable sensors disposed at locations with different magnetic field strengths in the regions of interest configured to receive magnetic responses; and correlating all the said received magnetic responses to one or more material qualities and/or material phases of the steel component, wherein said one or more material qualities includes regions of higher hardness, regions of metal loss, regions of surface cracks, amount of undesirable phases and combinations thereof. The method may optionally include one or more of the following: Element 1: wherein the steel component is a steel plate, and wherein the scanning step of the steel metal plate occurs after hot rolling and/or an accelerated cooling step; Element 2: wherein the scanning step is conducted manually using a trolley or a hand held device or automatically using an automated scanning system; Element 3: wherein the received magnetic responses is analyzed online or stored and analyzed offline; Element 4: wherein if the amount of undesirable phases present in the steel component is above a predetermined threshold level, the steel component is rejected from further processing or is remediated; Element 5: Element 4 and wherein the treatment is a tempering treatment step; Element 6: further including providing feedback to the steel component processing steps to minimize the formation of the amount of undesirable phases; Element 7: wherein the material phase includes at least one of austenite, martensite, ferrite, pearlite, bainite, lath bainite, acicular ferrite, or quasi-polygonal ferrite; Element 8: wherein the steel component is a steel plate, and wherein the steel metal plate includes a flat plate and curved plate; Element 9: wherein the method includes providing a computer-controlled automatic moving platform to move the magnets, and two or more suitable sensors to detect magnetic response at different spatial locations; Element 10: wherein the method includes providing a manually controlled to translating and rotating platform to move the magnets, and two or more suitable sensors to detect magnetic response at different spatial locations; and Element 11: wherein the method includes providing a handheld device that includes at least one DC magnet and at least two suitable sensors. Examples of combinations include, but are not limited to, one of Elements 9-11 in combination with one or more of Elements 1-8; Element 1 in combination with one or more of Elements 2-11; Element 4 and optionally Element S in combination with Element 6; Element 7 in combination with Element 3; and Element 4 and optionally Element 5 in combination with Element 3.

Another example embodiment is a method of utilizing a nondestructive evaluation method to screen steel pipeline seam welds composed of at least one hysteretic ferromagnetic material to identify material phases andlor material qualities of the seam welds comprising the steps of: providing a DC magnetic field from a magnet to a steel pipeline composed of at least one hysteretic ferromagnetic material; scanning the steel pipeline and recording magnetic responses from two or more suitable sensors disposed at locations with different magnetic field strengths in the regions of interest configured to receive magnetic responses; and correlating all the said received magnetic responses to one or more material qualities and/or material phases of the seam weld of the steel pipeline, wherein said one or more material qualities includes regions of higher hardness, regions of metal loss, regions of surface cracks, amount of undesirable phases and combinations thereof. The method may optionally include one or more of the following: Element 12: wherein the nondestructive evaluation method is incorporated onto a pipeline inspection gauge (PIG) for detecting the one or more material qualities of the seam weld of the steel pipeline; Element 13: Element 12 and wherein the PIG inspects the inside diameter of the steel pipeline; Element 14: wherein the received magnetic responses is stored and analyzed online during pipeline inspection or stored and analyzed offline from the pipeline inspection; Element 15: wherein if the amount of undesirable phases present in the steel pipeline at a certain location of the seam weld is above a predetermined threshold level, the affected section of the pipeline is replaced at the certain location of the seam weld, or remed.iated by a metallurgical treatment at the certain location of the seam weld or repair welding in the certain location of the seam weld; Element 16: Element 15 and wherein the metallurgical treatment is a tempering or annealing treatment step; Element 17: wherein the material phase includes at least one of austenite, martensite, ferrite, pearlite, bainite, lath bainite, acicular ferrite, or quasi-polygonal ferrite; Element 18: wherein the nondestructive evaluation method includes multiple copies of one magnet and two or more suitable sensors located at positions around the circumference of a pipeline inspection gauge (PIG), which is placed at the inner side of pipeline; Element 19: Element 18 and wherein the nondestructive evaluation method includes at least one DC magnet and at least two or more suitable sensors placing at a preferred nearby location of the inner side of steel pipeline; Element 20: Element 18 and wherein the nondestructive evaluation method includes at least one horseshoe magnet with its two legs contacting the inner wall of pipeline; Element 21: Element 18 and wherein the nondestructive evaluation method includes at least one magnetic sensor located at the center of the horseshoe magnets and at least one magnetic sensor located at the trailing side of the horseshoe magnets; and Element 22: wherein the method includes providing a handheld device for scanning the steel pipeline that includes at least one DC magnet and at least two suitable sensors. Examples of combinations include, but are not limited to, two or more of Elements 12-16 in combination; two or more of Elements 18-21 in combination; one or more of Elements 12-16 in combination with one or more of Elements 18-21; Element 17 in combination with any of the foregoing; and Elements 17 and 22 in combination.

Yet another example embodiment is a method of utilizing a nondestructive evaluation method to screen welds of steel piping or pipes or welded structure including but not limited to girth welds or fillet welds or lap welds or butt welds in systems composed of at least one hysteretic ferromagnetic material to identify material phases and/or material qualities of the girth welds comprising the steps of: providing a DC magnetic field from a magnet to a steel pipe composed of at least one hysteretic ferromagnetic material; scanning the weld and recording magnetic responses from two or more suitable sensors disposed at locations with different magnetic field strengths in the regions of interest configured to receive magnetic responses; and correlating all the said received magnetic responses to one or more material qualities and/or material phases of the one or more welds of the steel pipe or piping or welded structure, wherein said one or more material qualities includes regions of higher hardness, regions of metal loss, regions of surface cracks, amount of undesirable phases and combinations thereof. The method may optionally include one or more of the following: Element 23: wherein the systems include risers, pipelines or other piping systems; Element 24: wherein the nondestructive evaluation method is incorporated onto a manual or automatic inspection tool capable of scanning and inspecting the inside diameter or outside diameter of the system for detecting the one or more material qualities of the one or more welds of the system; Element 25: Element 24 and wherein the manual inspection tool for the inside diameter and/or outside diameter of the steel pipeline or piping is a tethered or pulled system; Element 26: Element 24 and wherein the automatic inspection tool for the inside diameter and/or outside diameter of the steel pipeline or piping is a robotic crawler system; Element 27: Element 24 and wherein the received magnetic responses is stored and analyzed online during pipeline or piping or welded structure inspection or stored and analyzed offline from the pipeline or piping or welded structure inspection; Element 28: wherein if the amount of undesirable phases present in the weld is above a predetermined threshold level, the weld is replaced or remediated by a metallurgical treatment; Element 29: Element 28 and wherein the metallurgical treatment is a temper beading step for the next weld pass of the weld or a post weld heat treatment step before proceeding to the scan and inspect of the next weld; Element 30: wherein the material phase includes at least one of austenite, martensite, ferrite, pearhte, bainite, lath bainite, acicular ferrite, or quasi-polygonal ferrite; Element 31: Element 24 and wherein the nondestructive evaluation tool includes one or multiple copies of one magnet and two or more suitable sensors; Element 32: Element 31 and wherein the magnets and sensors are located at positions around the circumference of pulled pipeline inspection tool, which is placed at the inner andlor outer side of pipeline; Element 33: Element 32 and wherein the one or multiple copies of one magnet and two or more suitable sensors can be placed in an arrangement to cover the circumference of the inspection tool at one or more longitudinal locations; Element 34: Element 24 and wherein the nondestructive evaluation method includes at least one magnet, and at least two sensors placing at a preferred nearby location of the system; Element 35: Element 24 and wherein the nondestructive evaluation method includes at least one DC magnet and at least two or more suitable sensors placing at a preferred nearby location of the inner side of steel pipeline; Element 36: wherein the nondestructive evaluation method includes at least one horseshoe magnet with its two legs contacting the inner wall of pipeline; Element 37: wherein the nondestructive evaluation method includes at least one magnetic sensor located at the center of the horseshoe magnets and at least one magnetic sensor located. at the trailing side of the horseshoe magnets; and Element 38: wherein the method includes providing a handheld device for scanning the steel pipe line that includes at least one DC magnet and at least two suitable sensors. Examples of combinations include, but are not limited to, one of Elements 25 and 26 in combination with Element 24 and one or more of Elements 27-33; one of Elements 34 and 35 in combination with Element 24 and one or more of Elements 27-33; one of Elements 25 and 26 in combination with Element 24 and one or more of Elements 36-38; One of Elements 34 and 35 in combination with Element 24 and one or more of Elements 36-38; two or more of Elements 24, 27-33, and 36-38 in combination; and Element 23 in combination with any of the foregoing.

Another example embodiment is a method of utilizing a nondestructive evaluation method to identify material phases and material qualities in steel components (e.g., steel metal plates, bolts, forgings, castings, and the like)and pipeline welds, and welding types and heat treatment states of steel components and steel pipelines composed of at least one hysteretic ferromagnetic material comprising the steps of: providing a DC magnetic field from a magnet to to a steel component or steel pipeline composed of at least one hysteretic ferromagnetic material; scanning the steel component or steel pipeline and recording magnetic responses from two or more suitable sensors disposed at locations with different magnetic field strengths in the regions of interest configured to receive magnetic responses; and correlating all the said received magnetic responses to one or more material qualities and/or material phases of the steel component or steel pipeline, wherein said one or more material qualities includes regions of higher hardness, regions of metal loss, regions of surface cracks, amount of undesirable phases and combinations thereof. The method may optionally include one or more of the following: Element 39: wherein the steel pipeline seam welds includes post weld heat-treated low-frequency ERW pipes, non-heat-treated low-frequency ERW pipes, post weld heat-treated high-frequency ERW pipes, and non-heat-treated high-frequency ERW pipes; Element 40: wherein the nondestructive evaluation method includes one or more copies of one magnet and two or more suitable sensors; Element 41: wherein the nondestructive evaluation method includes a computer-controlled automatic moving platform to move the magnet and two or more suitable sensors to detect magnetic responses at different spatial locations; Element 42: wherein the nondestructive evaluation method includes a manually controlled translating and rotating platform to move the magnet and two or more suitable sensors to detect magnetic responses at different spatial locations; Element 43: wherein the nondestructive evaluation method includes a handheld device that includes at least one magnet and at least two sensors; Element 44: wherein the received magnetic responses is stored and analyzed online during steel component or pipeline inspection or stored and analyzed offline from the steel component or pipeline inspection; Element 45: wherein if the amount of undesirable phases present in the steel component or pipeline is above a. predetermined threshold level, the steel materials at that location is replaced or remediated by a metallurgical treatment; Element 46: Element 45 and wherein the metallurgical treatment is a tempering step or a post weld heat treatment step; Element 47: wherein the material phase includes at least one of austenite, martensite, ferrite, pearlite, bainite, lath bainite, acicular ferrite, or quasi-polygonal ferrite; Element 48: wherein the nondestructive evaluation method is used to determine the seam weld type, the girth weld type and post weld heat treatment of the seam weld or girth weld; and Element 49: Element 48 and wherein seam weld type is LF-ERV or HF-ERV.

Examples of combinations include, but are not limited to, one of Elements 41-43 in combination with one or more of Elements 39, 40, and 44-49; two or more of Elements 39, 40, and 44-49 in combination; Element 45 and optionally Element 46 in combination with Element 48 and optionally Element 49; and Element 44 in combination with Element 40.

While the device and method of using nondestructive material inspection of the to subject disclosure have been shown and described with reference to embodiments, those skilled in the art will readily appreciate that changes and/or modifications may be made thereto without departing from the spirit and scope of the subject disclosure.

1. A method of utilizing a nondestructive evaluation method to inspect/screen steel component composed of at least one hysteretic ferromagnetic material to identify material phases and/or material qualities of the steel component comprising the steps of:
providing a DC magnetic field from a magnet to a steel component composed of at least one hysteretic ferromagnetic material;
scanning the steel component and recording magnetic responses from two or more suitable sensors disposed at locations with different magnetic field strengths in the regions of interest configured to receive magnetic responses; and
correlating all the said received magnetic responses to one or more material qualities and/or material phases of the steel component,
wherein said one or more material qualities includes regions of higher hardness, regions of metal loss, regions of surface cracks, amount of undesirable phases and combinations thereof.

2. The method of claim 1, wherein the component is a steel metal plate, and wherein the scanning step of the steel metal plate occurs after hot rolling and/or an accelerated cooling step.

3. The method of claim 1, wherein the scanning step is conducted manually using a trolley or a hand held device or automatically using an automated scanning system.

4. The method of claim 1, wherein if the amount of undesirable phases present in the steel component is above a predetermined threshold level, the steel component is rejected from further processing or is remediated.

5. The method of claim 1, wherein the material phase includes at least one of austenite, martensite, ferrite, pearlite, bainite, lath bainite, acicular ferrite, or quasi-polygonal ferrite.

6. A method of utilizing a nondestructive evaluation method to screen steel pipeline seam welds composed of at least one hysteretic ferromagnetic material to identify material phases and/or material qualities of the seam welds comprising the steps of:
providing a DC magnetic field from a magnet to a steel pipeline composed of at least one hysteretic ferromagnetic material;
scanning the steel pipeline and recording magnetic responses from two or more suitable sensors disposed at locations with different magnetic field strengths in the regions of interest configured to receive magnetic responses; and
correlating all the said received magnetic responses to one or more material qualities and/or material phases of the seam weld of the steel pipeline,
wherein said one or more material qualities includes regions of higher hardness, regions of metal loss, regions of surface cracks, amount of undesirable phases and combinations thereof.

7. The method of claim 6, wherein the nondestructive evaluation method is incorporated onto a pipeline inspection gauge (PIG) for detecting the one or more material qualities of the seam weld of the steel pipeline.

8. The method of claim 7, wherein the pipeline inspection gauge (PIG) inpects the inside diameter of the steel pipeline.

9. The method of claim 8. wherein the received magnetic responses is stored and analyzed online during pipeline inspection or stored and analyzed offline from the pipeline inspection.

10. The method of claim 9, wherein if the amount of undesirable phases present in the steel pipeline at a certain location of the seam weld is above a predetermined threshold level, the affected section of the pipeline is replaced at the certain location of the seam weld, or remediated by a metallurgical treatment at the certain location of the seam weld or repair welding in the certain location of the seam weld.

11. The method of claim 10, wherein the metallurgical treatment is a tempering or annealing treatment step.

12. The method of claim 6, wherein the material phase includes at least one of austenite, martensite, ferrite, pearlite, bainite, lath bainite, acicular ferrite, or quasi-polygonal ferrite.

13. The method of claim 6, wherein the nondestructive evaluation method includes multiple copies of one magnet and two or more suitable sensors located at positions around the circumference of the pipeline inspection gauge (PIG), which is placed at the inner side of pipeline.

14. The method of claim 6, wherein the method includes providing a handheld device for scanning the steel pipeline that includes at least one DC magnet and at least two suitable sensors.

15. A method of utilizing a nondestructive evaluation method to screen welds of steel piping or pipes or welded structure including but not limited to girth welds or fillet welds or lap welds or butt welds in systems composed of at least one hysteretic ferromagnetic material to identify material phases and/or material qualities of the girth welds comprising the steps of:
providing a DC magnetic field from a magnet to a steel pipe composed of at least one hysteretic ferromagnetic material;
scanning the weld and recording magnetic responses from two or more suitable sensors disposed at locations with different magnetic field strengths in the regions of interest configured to receive magnetic responses; and
correlating all the said received magnetic responses to one or more material qualities and/or material phases of the one or more welds of the steel pipe or piping or welded structure,
wherein said one or more material qualities includes regions of higher hardness, regions of metal loss, regions of surface cracks, amount of undesirable phases and combinations thereof.

16. The method of claim 15, wherein the systems include risers, pipelines, or other piping systems.

17. The method of claim 15, wherein the nondestructive evaluation method is incorporated onto a manual or automatic inspection tool capable of scanning and inspecting the inside diameter or outside diameter of the system for detecting the one or more material qualities of the one or more welds of the system.

18. The method of claim 15, wherein if the amount of undesirable phases present in the weld is above a predetermined threshold level, the weld is replaced or remediated by a metallurgical treatment.

19. The method of claim 18, wherein the metallurgical treatment is a temper beading step for the next weld pass of the weld or a post weld heat treatment step before proceeding to the scan and inspect of the next weld.

20. The method of claim 15, wherein the nondestructive evaluation tool includes one or multiple copies of one magnet and two or more suitable sensors.
